(19) United States
(12) Patent Application Publication
(10) Pub. No.: US 2020/0131385 A1
(43) Pub. Date: Apr. 30, 2020

(54) METHOD OF MAKING POLYMER ARTICLES AND POLYMER COMPOSITES BY ADDITIVE PROCESSING AND POLYMER AND COMPOSITE ARTICLES

(71) Applicant: 3M INNOVATIVE PROPERTIES COMPANY, St. Paul, MN (US)

(72) Inventors: Jeffrey N. Bartow, West Saint Paul, MN (US); Fee Zentis, Waging am See (DE); Gabriele H. Gottschalk-Gaudig, Mehring (DE); Xuan Jiang, Shanghai (CN); Klaus Hintzer, Kastl (DE); Per Miles Nelson, Woodbury, MN (US)

(21) Appl. No.: 16/631,799

(22) PCT Filed: Jul. 18, 2018
(86) PCT No.: PCT/IB2018/055355

§ 371 Date: Jan. 16, 2020

Related U.S. Application Data
(60) Provisional application No. 62/534,448, filed on Jul. 19, 2017.

(51) Int. Cl. C09D 11/107; C09D 11/101; C09D 11/033; B33Y 10/00; B29C 64/165; B33Y 70/00

(52) U.S. Cl. CPC C09D 11/107; C09D 11/101; C09D 11/033; B29K 2027/18; B29C 64/165; B33Y 70/00; B33Y 10/00

(57) ABSTRACT

Provided is a method of producing polymer articles comprising (i) subjecting a composition to additive processing in an additive processing device containing at least one energy source wherein the composition comprises particles of a first polymer, particles of a second polymer and at least one binder material capable of binding the polymer particles to form a layer in a part of the composition that has been exposed to the energy source of the additive processing device; (ii) subjecting at least a part of the composition to exposure of the energy source to form a layer comprising the polymer particles and binder material; (iii) repeat step (ii) to form a plurality of layers to create an article; and wherein the first polymer is selected from polymers having a melting point above of at least 250° C. or a glass transition temperature (Tg) of greater than 70° C. and is not a fluoropolymer and wherein the second polymer is a fluoropolymer. Also provided are materials obtained by this method and articles containing such materials.

### FIELD

The present disclosure relates to methods of making polymer articles and polymer composites. The present disclosure also relates to articles and composites produced by the methods and their applications.

### BACKGROUND

High-temperature-stable polymers are increasingly used as replacement for metal components in particular in the automotive and aircraft industries, but also in the healthcare industries, to provide light-weight but temperature-stable and durable materials. In particular polymers that are of high mechanical and high temperature stability are used for such a purpose. Such polymers are typically thermoplastic resins having a melting temperature above 250° C. or even above 280° C. or even above 300° C. Other high-temperature stable-polymers have glass transitions temperatures of 60° C. or higher, do not melt but decompose at temperatures above 250° C., above 280° C. or even above 300° C. High-temperature-stable polymers include polyarylether ketones, polyamides, polyimides, polyamide imides, polyphenylene sulfides, and polyphenylene sulfones. High-temperature-stable polymers, however, often have insufficient resistance to wear or show insufficient friction behavior, in particular when used as sliding parts at high forces, high temperatures, or high rotation.

Fluoropolymers, however, show high resistance to wear, heat and chemicals and also have low frictional coefficients but typically have poor mechanical properties.

Composites materials of fluoropolymers with other thermoplastic polymers can combine the properties of both materials. Typically, polymer composites are prepared by melt-kneading or extruding blends of the polymers. However, most of the high-performance polymers, in particularly polyaryl ether ketones, are not miscible or are only poorly miscible with fluoropolymers. In addition, homopolymers of tetrafluoroethylene or comonomers of tetrafluoroethylene with a low comonomer content can have such high melt viscosities such that they cannot be processed by conventional melt processing techniques used for mixing non-miscible polymers like melt-kneading or melt extrusion. Such fluoropolymers are referred to in the art as “non melt-processable fluoropolymers”. Therefore, the fluoropolymers do not mix well with the polymer phase of high-temperature-stable polymers and rather large agglomerates of fluoropolymer particles are found in composite articles made from both materials. This is disadvantageous because it may negatively impact the mechanical and friction properties of the composite material.

An approach to provide homogeneous fluoropolymer-polyaryl ether ketone composites is described in EP 2 881 430 B1 in which small particles sizes of fluoropolymers in a polyaryl ether ketone phase are reported for certain melt-processable fluoropolymers.

There is a need to provide alternative methods for making shaped articles of high-temperature-stable polymers. There is also a need for alternative methods of making composites, in particular shaped composites of high-temperature-stable polymers and fluoropolymers. Favorably such methods provide a homogeneous distribution of fluoropolymer particles, in particular small particles, in the composites.

### SUMMARY

Therefore, in the following there is provided a method of producing polymer articles comprising
(i) subjecting a composition to additive processing in an additive processing device containing at least one energy source wherein the composition comprises particles of a first polymer, particles of a second polymer and at least one binder material capable of binding the polymer particles to form a layer in a part of the composition that has been exposed to the energy source of the additive processing device;
(ii) subjecting at least a part of the composition to exposure of the energy source to form a layer comprising the polymer particles and binder material;
(iii) repeat step (ii) to form a plurality of layers to create an article; and wherein the first polymer is selected from polymers having a melting point above of at least 250° C. or a glass transition temperature (Tg) of greater than 70° C. and is not a fluoropolymer and wherein the second polymer is a fluoropolymer.

In another aspect there is provided a 3D-printable composition wherein the composition comprises particles of a first polymer, particles of a second polymer and at least one binder material capable of binding the polymer particles to form a layer comprising the particles in a part of the composition that has been exposed to the energy source of the additive processing device and wherein the first polymer is selected from polymers having a melting point above of at least 250° C. or a glass transition temperature (Tg) of greater than 70° C. and wherein the first polymer is not a fluoropolymer and wherein the second polymer is a fluoropolymer.

In yet another aspect there is provided an article comprising a shaped composition comprising from about 5% to 35% by weight of binder material, from 10% to 80% by weight of first polymer and from 10 to 80% by weight of a second polymer and from 0 to 15% by weight of water and from 0% to 30% by weight of other ingredients, wherein the total amounts of ingredients is 100% by weight, wherein either the second polymer or the first polymer or both are present as and wherein the first polymer is selected from polymers having a melting point above of at least 250° C. or a glass transition temperature (Tg) of greater than 70° C. and wherein the first polymer is not a fluoropolymer and wherein the second polymer is a fluoropolymer.

In a further aspect there is provided a composite material comprising more than 50% of a second polymer and up to 49% of a first polymer and wherein the average particle sizes of the first polymers is less than 50 μm, preferably less than 25 μm or even less than 15 μm or less than 10 μm or even less than 5 μm and wherein the first polymer is selected from polymers having a melting point above of at least 250° C. or a glass transition temperature (Tg) of greater than 70° C. and wherein the first polymer is not a fluoropolymer and wherein the second polymer is a fluoropolymer.

In yet another aspect there is provided a composite material comprising more than 50% of a first polymer and up to 49% of a second polymer and wherein the average particle sizes of the second polymer is less than 50 μm, preferably less than 25 μm or even less than 15 μm or less than 10 μm or even less than 5 μm and wherein the first polymer is selected from polymers having a melting point above of at least 250° C. or a glass transition temperature (Tg) of greater than 70° C. and wherein the first polymer is not a fluoropolymer and wherein the second polymer is a fluoropolymer.

Further provided are articles comprising the composite material.

### DETAILED DESCRIPTION

Before any embodiments of this disclosure are explained in detail, it is to be understood that the disclosure is not limited in its application to the details of construction and the arrangement of components set forth in the following description. Also, it is to be understood that the phraseology and terminology used herein is for the purpose of description. Contrary to the use of “consisting”, the use of “including,” “containing”, “comprising,” or “having” and variations thereof is meant to encompass the items listed thereafter and equivalents thereof as well as additional items. The use of “a” or “an” is meant to encompass “one or more”. Any numerical range recited herein describing a physical parameter or amounts and concentration of ingredients is intended to include all values from the lower value to the upper value of that range and including its endpoints. For example, a concentration range of from 1% to 50% is intended to be an abbreviation and to expressly disclose the values between the 1% and 50%, such as, for example, 2%, 40%, 10%, 30%, 1.5%, 3.9% and so forth.

All references cited herein are incorporated by reference unless stated otherwise. Unless specified otherwise, cited norms (e.g. DIN, ASTM, ISO etc) are the versions in force in Jan. 1, 2016. In case a norm had expired before Jan. 1, 2016 the most recent active version is referred to herein.

Amounts of ingredients expressed by weight percentages (% wt, % by weight, wt %) are based on the total weight of the composition unless stated otherwise. The total weight of the composition corresponds to 100% by weight.

Amounts of ingredients expressed by mole percentages (% moles, % by moles, mole %) are based on the molar amount of the composition unless stated otherwise. The total molar amount of a composition corresponds to 100% by moles.

Shaped articles of high performance polymers, composite compositions of high performance polymers and fluoropolymer and shaped composites can be prepared by additive processing according to the methods of the present disclosure.

An advantage of the methods and compositions provided herein is that not only prototypes of high performance polymers and composite materials can be produced at low costs, but also that articles of these materials with complex shape and design may be created that may not be available through conventional processing or only at higher costs.

Another advantage of the methods and compositions provided herein is that composite materials with a homogeneous distribution of fluoropolymer particles, and in particular of small particle size and low degree of agglomeration in a polymer phase other than a fluoropolymer phase can be achieved. This may lead to composite articles with improved properties.

Despite using binder materials, the composite materials may have a high density and/or a low void content.

Another advantage of the methods and compositions provided herein is that articles of high performing polymers and composite articles can be prepared that are of small dimension and have complex structures.

Another advantage of the present methods is that the degree of porosity of the articles and composites can be controlled to create articles of low or high porosity.

Additive Processing

Additive processing, also known as “3D printing,” or “additive manufacturing (AM),” refers to a process to create a three-dimensional object typically by sequential deposition of materials in defined areas, typically by generating successive layers of material. The object is typically produced under computer control from a 3D model or other electronic data source by an additive printing device typically referred to as a 3D printer. The term “3D printer” and “additive processing device” are used herein interchangeably and generally refer to a device by which additive processing can be carried out. The terms “3D-printing” and “3D-printable” are used likewise and mean additive processing and suitable for additive processing.

Additive processing devices are devices by which sequential deposition of material in defined areas can be achieved, typically by deposition of volume elements, such as layers. Successive layers are built up, layer-on-layer, to create a three-dimensional object. Typically, the device is computer-controlled. Further typically, the device creates the object based on an electronic image (blueprint) of the object to be created. The 3D printer contains an energy source that applies energy to a localised area in a 3D-printable composition. The energy applied may be, for example, heat or irradiation or both. The energy source may include a light source, for instance a light source emitting non-visible light, e.g., ultraviolet light (UV light), a laser, e-beam generators, microwave generator and other sourcing capable of focussing energy to defined areas of the 3D-printable composition. The energy source may be moved to defined areas over the surface of the 3D printable composition, or the printable composition may be moved in a defined way towards and away from the energy source, typically all under computer control.

One or even several energy sources may be used, arranged at different positions in the additive processing device. Typically, the additive printing device contains a platform onto which the printable material is provided. The platform, for example, can be moved towards the energy source or away from it, typically, by the distance of the layers to be formed on the platform. Typically, this is also done under computer control. The device may further contain a device such as a wiper blade or an injection nozzle by which new printable material is provided and can be applied over the layer formed for successive layer-on-layer building. Support structures may be used and later removed in case the object to be created is complex or requires structural support during its creation. Additive printing devices as known and that are commercially available can be used for the methods provided herein.

According to the present disclosure, the volume elements or layers are formed by using a 3D printable composition containing polymer particles and at least one binder material. Exposure of the composition to the energy source of the device, or more precisely, to the energy emitted from the energy source, causes the binder material to bind the polymer particles into a volume element. Typically, the viscosity of the binder material changes upon exposure of a selected area of the composition, for example the binder material melts, gels, solidifies or polymerizes and keeps the polymer particles embedded in the binder material in a defined position. Although referred to herein as “binder” material, no formation of a chemical bond (e.g., to the fluoropolymer material) has to occur. The interaction may be physical or chemical or both, but should be sufficient to keep the polymer particles in a defined position by the “activated” binder material, for example by molten or polymerized binder material.

Preferably, the binder material polymerizes in areas of the composition exposed to the energy source and through polymerization the binder material keeps embedded polymer particles in a defined position.

A typical example of this type of additive manufacturing technique is known in the art as ‘stereolithography’ (SL) or ‘vat polymerization’(VP) although other 3D printing methods may be used. This type of additive manufacturing process works by focussing electromagnetic irradiation (including, for example UV light) on to a vat of 3D printable composition containing polymerizable material. The 3D printable composition is typically a liquid. With the help of computer aided manufacturing or computer aided design software (CAM/CAD), the irradiation is used to draw a pre-programmed design or shape on to the surface of the 3D-printable composition. Because the 3D-printable composition is reactive to the irradiation, the composition becomes more viscous, solidified or gels and forms a single layer of the desired 3D object on the areas exposed to the irradiation. This process is repeated for each layer of the design until the 3D object is complete. Typically, the 3D printer used for stereolithography contains an elevator platform that descends a distance equal to the thickness of a single layer of the design (typically 0.05 mm to 0.15 mm, or 0.001mm to 0.15 mm) into the vat containing the 3D printable composition before a new layer is formed by irradiation. A blade filled with new printable material may sweep across a cross section of the layer, re-coating it with fresh material. Alternatively, a nozzle may be used or other devices of providing new printable material. The subsequent layer is traced, joining the previous layer. A complete 3D object can be formed using this process. Depending on the design of the additive processing device another typical method raises or lowers the build platform further than one layer or volume element so that the printable material is able to flow easily over the previous layer/volume element. Upon returning to the desired step height the previous layer is uniformly covered. The subsequent is traced joining the previous layer.

Preferably, irradiation with light (preferably UV light) is used and a polymerizable binder material is used in the 3D printable composition that is reactive to light, or UV light, or is reactive to initiators that are activated by light or UV light as the case may be. However, irradiation with other wavelengths may also be used, for example from the visible or invisible light (e.g. IR) and including X-rays and e-beams. In that case a polymerizable material is chosen that is reactive to such irradiation or that is reactive to polymerization initiators that are activated by such irradiation.

Conditions for effective irradiation may vary depending on the type of irradiation used and the type of polymerizable materials chosen. Polymerizable materials and polymerization initiators may be selected that are responsive to various types of irradiation for example to irradiation with visible or invisible lights. For example, irradiation with light of wavelengths from 1 to 10,000 nm, for example but not limited to 10 to 1,000 nm may be used. The irradiation may be monochromatic or polychromatic depending on the reactivity of the polymerizable system chosen.

UV irradiation typically includes irradiation with a wavelength between 10 and 410 nm. UV irradiation may be generated from a UV source, like a laser, a mercury lamp or UV LEDs. UV LEDs (light emitting diodes, LED) are commercially available that produce monochromatic irradiation at wave length of 365 nm, 385 nm and 405 nm within an error margin of +/−10 nm. Infrared irradiation typically includes irradiation with electromagnetic waves of a wave length from 1 mm to 750 nm. Irradiation with visible light typically includes irradiation with a wave length between 410 and 760 nm.

Depending on the complexity of the article design supporting structures may be attached to the elevator platform to prevent deflection or delamination due to gravity and to hold cross sections in place in order to resist lateral pressure from the resin-filled blade.

Although described in greater detail for stereolithography, the 3D printable compositions may be used in other 3D printing methods as well. For example, 3D printable compositions according to the present disclosure that are viscous compositions or extrudable pastes can be processed by extruding the composition through an extruder on the selected location of a build platform. The energy source may be placed on the exit of the extruder or elsewhere and the material extruded on the platform is irradiated at the selected location to cause the polymerizable binder material to polymerize and to form a volume element. This step may be repeated until an object is formed.

Alternatively, a non-polymerizable binder material may be used and the binder material may be “activated” by bringing it to the melt in selected areas of the composition by an energy source of the 3D printer, for example a laser. The 3D-printable compositions may be pastes or solid mixtures of particles, for example powders. The polymer particles may be coated with the binder material. 3D printing methods using solid particle mixtures and melting to create volume elements are known in the art as laser sintering or laser melting.

The methods provided herein can be carried out in known and commercially available additive printing devices, for example known devises for stereolithography or vat polymerization. Examples of commercially available 3D printers include, but are not limited to 3D printers from ASIGA, Anaheim, Calif., USA for vat polymerization printing. However, also other 3D printing methods may be used. For example, the 3D-printable compositions may be extruded as pastes through one or more nozzles and subjected to the energy source upon which the binder polymerizes. Examples include printers from Hyrel 3D, Norcross, Ga. 30071, such as Hyrel System 30M printer with extrusion heads. In such printers the 3D-printable compositions are adjusted by their compositions to have the required viscosity, for example by increasing the polymer content.

Typical known methods and their 3D printers have been described, for example, in “Additive Processing of Polymers” by B. Wendel et al in Macromol. Matter. Eng. 2008, 293, 799-809.

3D-Printable Compositions

The compositions provided in the present disclosure are suitable for additive processing and are also referred to herein as “3D-printable compositions.” They comprise particles of a first polymer and at least one binder material, preferably a polymerizable binder material. Preferably, the 3D-printable compositions comprise particles of a second polymer. The 3D-printable compositions may be dispersions of particles of the first polymer in a liquid medium, or in the binder material or both. Preferably, the 3D-printable compositions comprise a dispersion of particles of the first and of a second polymer in a dispersion medium or in the binder material. The compositions are preferably liquid dispersions, more preferably aqueous dispersions but can also be extrudable dispersions such as pastes. The compositions may also be solid compositions of polymer particles. In this case the binder preferably is not a polymerizable binder but a binder activated by melting or softening. The compositions and their ingredients will be described in greater detail below.

First Polymer

The first polymer typically may be a thermoplast having a melting point of at least 250° C., preferably at least 280° C., more preferably at least 320° C. In addition, or alternatively the first polymer may have a glass transition temperature of at least 60° C., or at least 80° C., preferably at least 90° C.

The first polymer and binder material are selected that the first polymer does not decompose at the degradation or combustion temperature of the binder material but only at a higher temperature. Also, preferably the first polymer does not decompose at the melting temperature of the second polymer but only at a higher temperature. Preferably the first polymer does not decompose at a temperature at which the binder material or combusts at a temperature below 250° C., preferably below 280° C., more preferably below 320° C. and most preferably below 390° C. In case of composite materials

The first polymer may have a melt viscosity of at least 0.10 kNsm⁻² at 60 sec⁻¹ at 390° C. (ASTM D3835).

The first polymer may have a heat deflection temperature of at least 190° C. or at least 230° C. under a load of 0.45 MPa measured according to ASTM D648.

The first polymer may have a temperature retraction temperature (TR-10, ASTM D 1329) of −19° C. or less, for example −25° C. or even −30° C. or less.

The first polymer may a polyarylether ketone (PAEK), a polyamide, for example PA4.6 and PA 6.6, a polyphenylene sulfide, a polyphenylene sulfone, a polyimide, a polyamide imide or a copolymer or block polymer containing such polymers as copolymers or block units. Preferably the polymer comprises repeating units that are aromatic. Preferably the second polymer is polyarylether ketone. Polyarylether ketones contain repeating units of at least two aryl groups linked either by an ether or by a ketone group. Polyarylether ketones include polyether ketones (PEKs). PEKs typically contain repeating units corresponding to the general formula:

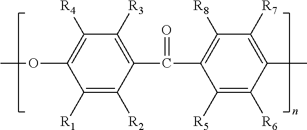

wherein R₁-R₈ may be different or identical substituents. Preferably, R₁-R₈ are all hydrogen. Polyaryl ether ketones also include polyether ether ketones (PEEKs), polyether ketone ketones (PEKKs), polyether ether ether ketones (PEEEKs), polyether ether ketone ketones (PEEKKs), and polyether ketone ether ketone ketones (PEKEKK). A polyether ether ketone (PEEK) comprises repeating units represented by the general formula:

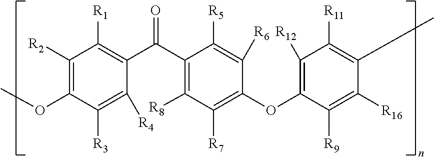

or by the formula:

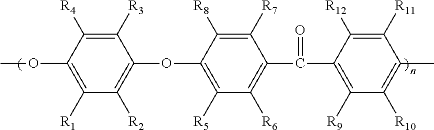

wherein R₁-R₈ may be different or identical substituents and the substituents may be linear or branched. Preferably R₁-R₈ are all hydrogen atoms.

Polyether ketone ketones contain repeating units with two ketone links and one ether link in the repeating units. Polyether ether ketone ketones contain two ketone and two ether links in the repeating units. The other polyether ketones like PEEEK and PEKEKK contain ether and ketone links accordingly.

Polyarylether ketones are commercially available. PEEKs are commercially available for example under the trade designations KETASPIRE, GATONE, VESTAKEEP, and VICTREX. Preferably, the first polymer is a PEEK.

Preferably, the first polymer is present as a dispersion, preferably as aqueous dispersions. The particle size of the first polymer may include average sizes of from about 50 nm to 5,000 nm, or 100 to 1,000 nm or 60 nm to 600 nm as determined, for example, according to ISO 13321 (1996). Dispersions of such polymers, in particular aqueous dispersions, are also commercially available.

The 3D-printable compositions may comprise one or more than one first polymer, for example mixtures of different ones of the above polymers and also mixtures of the same type of polymers but of different properties such as molecular weight, melt viscosity, particle sizes etc.

The 3D-printable compositions may comprise various amounts of first polymer including but not limited to amounts from about 1% to about 70%, from about 10 to about 60%, or from about 1 to about 30% or from about 5 to about 25% by weight based on the total weight of the composition of the first polymer.

Second Polymer

The 3D-printable compositions of the present disclosure may contain particles of a second polymer. The second polymer is a fluoropolymer. The second polymer may contain one or more than one fluoropolymers.

Suitable fluoropolymers include homopolymers of tetrafluoroethylene and copolymers of tetrafluoroethylene with one or more perfluorinated comonomers, partially fluorinated or non-fluorinated comonomers. Perfluorinated comonomers include perfluorinated alpha olefins and perfluorinated alpha olefin ethers, i.e. olefins where the carbon-carbon double bond is in a terminal position.

Perfluorinated alpha olefins include compounds according to the formula:

R^{f}—CX³═CX¹X²

wherein X¹, X², X³ are either all F or two of X¹, X² and X³ are F and one is Cl. R^{f} is a linear or branched alkyl radical of 1-12 carbon atoms and of which all hydrogen atoms have been replaced by fluorine atoms. Examples include hexafluoropropylene (HFP) and, chlorotrifluoroethylene (CTFE).

Examples of perfluorinated alpha olefins further include ethers of the formula

R^{f}—O—(CF₂)ₙ—CF═CF₂,

wherein n represents 1, in which case the compounds are referred to as allyl ethers, or 0, in which case the compounds are referred to as vinyl ethers. R^{f} represents a linear or branched, cyclic or acyclic perfluorinated alkyl residue containing at least one catenary oxygen atom (in the context of this application, unless specified otherwise or implied by otherwise by the context, catenary atom means an ether-oxygen atom). R^{f} may contain up to 8, preferably, or up to 6 carbon atoms, such as 1, 2, 3, 4, 5 and 6 carbon atoms. Typical examples of R^{f} include linear or branched alkyl residues interrupted by one oxygen atom, and linear or branched alkyl residues containing 2, 3, 4 or 5 catenary ether oxygens. Further examples of R^{f} include residues containing one or more of the following units and combinations thereof: —(CF₂O)—, —(CF₂CF₂—O)—, (—O—CF₂)—, —(O—CF₂CF₂)—, —CF(CF₃)—, —CF(CF₂CF₃)—, —O—CF(CF₃)—, —O—CF(CF₂CF₃)—, —CF(CF₃)—O—, —CF(CF₂CF₃)—O—.

Further examples of R^{f} include but are not limited to: —(CF₂)ᵣ₁—O—C₃F₇, —(CF₂)ᵣ₂—O—C₂F₅, —(CF₂)ᵣ₃—O—CF₃, —(CF₂—O)ₛ₁—C₃F₇, —(CF₂—O)ₛ₂—C₂F₅, —(CF₂—O)ₛ₃—CF₃, —(CF₂CF₂—O)ₜ₁—C₃F₇, —(CF₂CF₂—O)ₜ₂—C₂F₅, —(CF₂CF₂—O)ₜ₃—CF₃,

wherein r1 and s1 represent 1, 2, 3, 4, or 5, r2 and s2 represent 1, 2, 3, 4, 5 or 6, r3 and s3 represent 1, 2, 3, 4, 5, 6 or 7; tl represents 1 or 2; t2 and t3 represent 1, 2 or 3.

Particular examples of perfluorinated alkyl allyl ethers (PAAEs) include unsaturated ethers according to the general formula:

CF₂═CF—CF₂—OR^{f}

wherein R^{f} represents a linear or branched, cyclic or acyclic perfluorinated alkyl residue. R^{f} may contain up to 10 carbon atoms, e.g. 1, 2, 3, 4, 5, 6, 7, 8, 9 or 10 carbon atoms. Preferably R^{f} contains up to 8, more preferably up to 6 carbon atoms and most preferably 3 or 4 carbon atoms. R^{f} may be linear, branched and it may contain or not contain a cyclic unit. Specific examples of R^{f} include perfluoromethyl (CF₃), perfluoroethyl (C₂F₅), perfluoropropyl (C₃F₇) and perfluorobutyl (C₄F₉), preferably C₂F₅, C₃F₇ or C₄F₉. In a particular embodiment R^{f} is linear and is selected from C₃F₇ or C₄F₉.

Specific examples of suitable perfluorinated alkyl vinyl ether comonomers (PAVEs) include: F₂═CF—O—CF₃, F₂C═CF—O—C₂F₅, F₂C═CF—O—C₃F₇, F₂C═CF—O—CF₂—O—(CF₂)—F, F₂C═CF—O—CF₂—O—(CF₂)₂—F, F₂C═CF—O—CF₂—O—(CF₂)₃—F, F₂C═CF—O—CF₂—O—(CF₂)₄—F, F₂C═CF—O—(CF₂)₂—OCF₃, F₂C═CF—O—(CF₂)₃—OCF₃, F₂C═CF—O—(CF₂)₄—OCF₃, F₂C═CF—O—(CF₂)₃—(OCF₂)₂—F, F₂C═CF—O—CF₂—(OCF₂)₃—CF₃, F₂C═CF—O—CF₂—(OCF₂)₄—CF₃, F₂C═CF—O—(CF₂O)₂—OCF₃, F₂C═CF—O—(CF₂O)₃—OCF₃, F₂C═CF—O—(CF₂O)₄—OCF₃.

Specific examples of suitable perfluorinated alkyl allyl ether (PAAEs) comonomers include: F₂═CF—CF₂—O—CF_{3;} F₂C═CF—CF₂—O—C₂F_{5;} F₂C═CF—CF₂—O—C₃F_{7;} F₂C═CF—CF₂—O—CF₂—O—(CF₂)—F, F₂C═CF—CF₂—O—CF₂—O—(CF₂) ₂—F, F₂C═CF—CF₂—O—CF₂—O—(CF₂)₃—F, F₂C═CF—CF₂—O—CF₂—O—(CF₂)₄—F, F₂C═CF—CF₂—O—(CF₂)₂—OCF₃, F₂C═CF—CF₂—O—(CF₂)₃—OCF₃, F₂C═CF—CF₂—O—(CF₂)₄—OCF₃, F₂C═CF—CF₂—O—(CF₂)₃—(OCF₂)₂—F, F₂C═CF—CF₂—O—CF₂—(OCF₂)₃—CF₃, F₂C═CF—CF₂—O—CF₂—(OCF₂)₄—CF₃, F₂C═CF—CF₂—O—(CF₂O)₂—OCF₃, F₂C═CF—CF₂—O—(CF₂O)₃—OCF₃, F₂C═CF—CF₂—O—(CF₂O)₄—OCF₃.

Perfluorinated alkyl allyl ethers (PAAEs) and alkyl vinyl ethers (PAVEs) as described above are either commercially available, for example from Anles Ltd. St. Peterburg, Russia or can be prepared according to methods described in U.S. Pat. No. 4,349,650 (Krespan) or international patent application no. WO 01/46107 (Worm et al) or in Modern Fluoropolymers, J. Scheirs, Wiley 1997 and the references cited therein or by modifications thereof as known to the skilled person.

In addition to using one comonomer with TFE, the present description also contemplates the use more than one comonomer including a combination of the above comonomers.

The fluoropolymers may contain more than 50% by weight (based on the fluoropolymer) of units derived from TFE. Preferably, the fluoropolymer contains more than 70% by weight of TFE and more preferably more than 80% by weight. The comonomer content of fluoropolymers may be up to 50% by weight, preferably up to 30% by weight and more preferably less than 20% by weight. Preferably, the comonomers are perfluorinated comonomers. In some embodiments, the comonomers may include partially fluorinated or non-fluorinated comonomers.

Preferably the fluoropolymers are perfluorinated and only contain units derived from perfluorinated comonomers, i.e. they contain 0% by weight of comonomers other than the perfluorinated comonomers. In one embodiment the polymers contain less than 2% by weight, preferably less than 1% by weight of copolymers other than the perfluorinated comonomers.

In a preferred embodiment the fluoropolymer is a homopolymer of TFE or a copolymer of TFE and one or more perfluorinated comonomers, preferably selected from HFP, CTFE, one or more perfluoroalkyl vinyl ether or one or more perfluoro alkyl allyl ether or combinations thereof. In one embodiment the amount of the perfluorinated comonomers may be up to 12% by weight based on the total weight of the fluoropolymer, preferably less than 1.0% or more preferably less than up to 0.1% by weight. Preferably the copolymer is perfluorinated (i.e. it does not contain any comonomers other than perfluorinated comonomers).

In one embodiment the fluoropolymer contains TFE, HFP and/or one or more perfluoroalkyl vinyl ether (PAVE) comonomer and no other comonomer. In another embodiment the fluoropolymer contains TFE, HFP and/or one or more perfluoroalkyl allyl ether (PAAE) comonomer and no other comonomer. In yet another embodiment the fluoropolymer contains TFE and HFP and/or a combination of PAVE and PAAE comonomers and no other comonomers.

In a preferred embodiment the fluoropolymer contains TFE and no comonomers or the amount of the comonomers is less than 2 wt % or less than 1.0 wt % or less than 0.1 wt %. Typical amounts include, for example, from about 0.1 to 2, or from 0.01 to 0.09 percent by weight or from 0.03 to 0.09 percent by weight (all based on the total weight of the polymer). Alternatively, the fluoropolymer contains TFE and no comonomers or the amount of the comonomers is less than 1.0 mole % or less than 0.1 mole %. Typical amounts include, for example, from about 0.01 to 0.09 mole % or from 0.3 to 0.9 mole % (all based on 100 mole % of polymer). Typical comonomers include perfluorinated comonomers, preferably comonomers selected from HFP, PAVE's, PAAE's and combinations thereof. Such polymers are typically not melt-processable.

In one preferred embodiment the fluoropolymer is PTFE, i.e. a TFE homopolymer or a TFE copolymer containing up to 1% by weight or less than 1 mole % of copolymers wherein the copolymers are perfluorinated comonomers as described above. PTFE is not melt-processable.

In one embodiment of the present disclosure the fluoropolymers is not melt-processable. Notmelt-processable fluoropolymers as used herein have a melt flow index (MFI) of 1.0 g/10 min or less at 372° C. using a 5 kg load (MFI 372/5 of less than 1.0 g/10 min), preferably a melt flow index (372/5) of less than 0.1 g/10 minutes. Fluoropolymers with a melt flow index (MFI) of 1.0 g/10 min or less at 372° C. using a 5 kg load (MFI 372/5 of less than 1.0 g/10 min), preferably a melt flow index (372/5) of 0.1 g/10 minutes or less, have such a high melt viscosity that they retain their shape despite being at a temperature above their melting points. This is advantageous for removing binder material by heat treatment and to provide dense fluoropolymer articles.

However, also melt-processable fluoropolymers, i.e. fluoropolymers with a higher MFI may be processed with the methods provided herein and 3D printed articles may be created from melt-processable fluoropolymers. In case of the melt-processable fluoropolymers, the heat treatment may have to be adjusted and chosen such that the melt-processable fluoropolymers do not melt such that the shape of the article may be affected. The melt-processable fluorothermoplasts have a melt flow index of greater than 1.0 g/10 min (MFI (372° C./5 kg)). Preferably, they have an (MFI (372° C./5 kg) from 1.1 to 50 g/10 min, more preferably from 1 to 20 or 1 to 5 g/10 minutes.

In one embodiment the fluoropolymer is a “melt processable” fluoropolymer. Such fluoropolymers are also copolymers of TFE. The same comonomers and combinations of comonomers as described above can be used. Melt-processable fluoropolymers include copolymers of TFE with perfluorinated, partially fluorinated or non-fluorinated comonomers, wherein the comonomer content is greater than 1% wt, or greater than 3% by weight and may be up to 30% wt (as used hereinabove and below the weight percentages are based on the total weight of the polymer—unless specified otherwise).

Examples of non-fluorinated comonomers include ethylene and propylene. Examples of partially fluorinated comonomers include alpha olefins containing fluorine atoms and hydrogens atoms. Examples include but are not limited to vinyl idene fluoride, vinyl fluoride and fluorinated alkyl vinyl and fluorinated alkyl allyl ether with hydrogen atoms in the alkyl chain and/or at the carbon-carbon double bond. Melt-processable fluoropolymers (also referred to as “thermoplasts” or “thermoplastics”) include but are not limited to: FEP (copolymers of TFE, HFP and other optional amounts of perfluorinated vinyl ethers); THV (copolymers of TFE, VDF and HFP), PFA (copolymers of TFE and perfluoro alkyl vinyl ethers and/or perfluoro alkyl allyl ethers) homonomers and copolymers of VDF (PVDF) and homo- and copolymers of chlortrifluoroethylene (CTFE) and copolymers of TFE and ethylene (ETFE).

Preferred melt-processable fluorothermoplasts include fluoropolymers with a melting point between 260 and 315° C., preferably 280° C. to 315° C.

In one embodiment the melt processable fluorothermoplasts are PFAs. PFAs are copolymers of TFE and at least one perfluoro alkyl vinyl ethers (PAVE's), perfluoro alkyl allyl ethers (PAAE) and combinations thereof. Typical amounts of copolymers range from 1.7% to 10% wt. Preferably, the PFAs have a melting point between 280° C. and 315° C., for example between 280° C. and 300° C.

In one embodiment the fluoropolymer is melt-processable and has an MFI greater than 50 g/10 min (MFI 372/5). In one embodiment, fluorothermoplasts with MFI's greater than 50 g/10 min (MFI 372/5) and/or with melting points below 300° C. or 280° C., or below 200° C. may be used, for example fluorothermoplasts with melting points between 150° C. and 280° C. These fluoropolymers require a milder heat treatment in the work-up procedure to avoid structural stability. The binder material may be removed not thermally but, for example, by solvent extraction, or binder material may be chosen that can be removed at low temperatures. Such materials may also preferably be processed as pastes and the 3D printable compositions may contain no water or only low amounts of water. This would avoid or reduce the heat treatment necessary to remove residual water in the work-up procedure.

In one embodiment of the present disclosure the fluoropolymers have a standard specific gravity (SSG) of between 2.13 and 2.23 g/cm³ as measured according to ASTM 4895. The SSG is a measure for the molecular weight of the polymer. The higher the SSG, the lower the molecular weight. In one embodiment ultra-high molecular weight PTFEs are used in the present disclosure, which means PTFE polymers having an SSG of less than 2.17 g/cm³, for example an SSG of between 2.14 and 2.16. Such PTFE polymers and their preparation is described, for example, in WO2011/139807.

In one embodiment, the fluoropolymers of the present disclosure have a melting point of at least 300° C., preferably at least 315° C. and typically within the range of 327+/−10° C. In some embodiments, the fluoropolymers have a melting point of at least 317° C., preferably at least 319° C. and more preferably at least 321° C. In a preferred embodiment, the fluoropolymer with such melting point is not melt-processable.

The fluoropolymers may have different polymer architectures and can be, for example core-shell polymers, random polymers or polymers prepared under continuous and constant polymerization conditions. The fluorothermoplasts may be linear or branched, for example in case they contain branched comonomers like HFP. Longer branches may be created by using branching modifiers in the polymerization as described, for example in WO2008/140914 A1.

Fluoropolymers as commercially available may be used. Fluorothermoplasts are described, for example, in “Fluoropolymer, Organic” in Ullmann's Encyclopedia of industrial chemisty, 7^{th} edition, 2013, Wiley-VCH Verlag Chemie, Weinheim, Germany.

In the 3D-printable compositions of the present disclosure the fluoropolymers typically are present as particles. Favourably, the fluorinated polymers are dispersed in the 3D-pintable compositions. Preferably, the fluorinated polymers have a small particle size to allow for a homogenous dispersion. Typically, the particle size corresponds to particle sizes obtained by preparing fluoropolymers in an aqueous emulsion polymerization as known in the art. The fluoropolymers typically have a particle size of less than 2,000 nm. Preferably, the fluoropolymer particles have an average particle size of from 50 to 1,500 nm, or from 50 to 1,00 nm, preferably from 50 nm to 500 nm, or more preferably from 70 to 350 nm. Using fluoropolymers of small particle sizes, for example particle sizes typically obtained by emulsion polymerisation of fluoropolymers where the resulting fluoropolymers have an average particle size of from 50 to 500 nm, or from 70 to 350 nm may favour the creation of a more homogeneous distribution of the fluoropolymer particles in the composite with the first polymer.

As an alternative to using aqueous fluoropolymer dispersions, fluoropolymer coagulated from such dispersions may be used although this is not preferred. The coagulated polymer particles may be dispersed in a solvent, typically an organic solvent. Alternatively, fluoropolymers obtained by suspension polymerization may be used, although this is also not preferred. Typically, particles resulting from suspension polymerizations have a greater particle size than the particle sizes obtained by aqueous emulsion polymerization. The particle sizes of polymers obtained by coagulation and/or suspension polymerization may be greater than 500 nm and may be even greater than 500 μm. Such particles may be milled to smaller particle sizes if desired. Preferably, all fluoropolymer particles in the 3D-printable composition are smaller than than 500 μm, preferably smaller than 50 μm and less, more preferably smaller than 5 μm. Practical manufacturing limits may dictate that such particles have a size of 0.01 μm or larger, 0.05 μm or larger. In other words, the present description includes populations of particle sizes beginning at 0.01, 0.05, 0.1 and 0.5 μm and up to sizes of 5, 50, or 500 μm.

Fluoropolymer particles of greater particle size may be milled to smaller particles.

In the 3D-printable compositions the fluoropolymers may be dispersed in the binder material or in a dispersing medium or dissolved in a solvent. The dispersing medium includes, for example water or an organic solvent or a combination thereof Organic solvents generally are liquid at room temperature, i.e. they have a melting point below 20° C. and a boiling point above 25° C., preferably above 50° or even above 70° C. Organic solvents include liquids having at least one carbon atom. Preferably, the 3D-printable compositions are aqueous compositions, i.e. compositions comprising water, for example comprising at least 5% by weight, preferably at least 10% by weight based on the weight of the composition of water. In a convenient way to prepare homogeneous 3D-printable compositions, an aqueous dispersion of the fluoropolymers is provided to which the other ingredients are added. Extrudable compositions may be created from dispersions that may then be upconcentrated, for example by removing water content through evaporation or thermal treatment. Another way of making extrudable pastes includes suspending or dispersing coagulated fluoropolymers in suitable solvents and combining them with the binders or other optional ingredients.

The fluoropolymers described herein and the aqueous fluoropolymer dispersions can be conveniently prepared by aqueous emulsion polymerization as described, for example, in U.S. Pat. No. 2,965,595, EP 1,533,325 and EP 0,969,027.

Various grades of fluoropolymers and fluoropolymer dispersions as described herein are commercially available, for example from Dyneon GmbH, Burgkirchen Germany and from other fluoropolymer producers including but not limited to Chemours, Daikin and Solvay.

The fluoropolymers used in the 3D-printable compositions are preferably prepared by aqueous emulsion polymerization. Preferably, they are provided as aqueous dispersions. The polymerization is typically carried out with fluorinated emulsifiers. The fluorinated emulsifiers stabilise the fluoropolymer dispersion. Typical emulsifiers include those that correspond to the formula

Q-R^{f}—Z-M

wherein Q represents hydrogen, Cl or F, whereby Q may be present in a terminal position or not, R^{f} represents a linear or cyclic or branched perfluorinated or partially fluorinated alkylene having 4 to 15 carbon atoms, Z presents an acid anion, such as COO⁻ or SO₃⁻ and M represents a cation including an alkali metal anion or an ammonium ion. Examples fluorinated emulsifiers include those described in EP 1 059 342, EP 712 882, EP 752 432, EP 86 397, U.S. Pat. Nos. 6,025,307, 6,103,843, 6,126,849, 5,229,480, 5,763,552; 5,688,884, 5,700,859, 5,895,799, WO00/22002 and WO00/71590. Typical examples include but are not limited to emulsifiers of the general formula:

[R^{f}—O-L-COO⁻]ᵢXᵢ⁺

wherein L represents a linear or branched or cyclic, partially or fully fluorinated alkylene group or an aliphatic hydrocarbon group, R^{f} represents a linear or branched, partially or fully fluorinated aliphatic group or a linear or branched partially or fully fluorinated group interrupted once or more than once with an oxygen atom, Xᵢ⁺ represents a cation having the valence i and i is 1, 2 and 3. In case the emulsifier contains partially fluorinated aliphatic group it is referred to as a partially fluorinated emulsifier. Preferably, the molecular weight of the emulsifier is less than 1,000 g/mole.

Specific examples are described in, for example, US Pat. Publ. 2007/0015937 (Hintzer et al.). Exemplary emulsifiers include: CF₃CF₂OCF₂CF₂OCF₂COOH, CHF₂(CF₂)₅COOH, CF₃(CF₂)₆COOH, CF₃O(CF₂)₃OCF(CF₃)COOH, CF₃CF₂CH₂OCF₂CH₂OCF₂COOH, CF₃O(CF₂)₃OCHFCF₂COOH, CF₃O(CF₂)₃OCF₂COOH, CF₃(CF₂)₃(CH₂CF₂)₂CF₂CF₂CF₂COOH, CF₃(CF₂)₂CH₂(CF₂)₂COOH, CF₃(CF₂)₂COOH, CF₃(CF₂)₂(OCF(CF₃)CF₂)OCF(CF₃)COOH, CF₃(CF₂)₂(OCF₂CF₂)₄OCF(CF₃)COOH, CF₃CF₂O(CF₂CF₂O)₃CF₂COOH, and their salts.

Therefore, in one embodiment, the 3D-printable compositions may contain one or more fluorinated emulsifiers. Typically, their amount is low (100 ppm or less or 50 ppm or less based on the weight of the composition in any event as low as 10 ppm, 5 ppm, or even low enough to be below the detection limits of the available analytical methods (therefore nominally 0 ppm, 0 ppb, or 0 ppt, depending on the limits of the chosen method)) because the fluorinated emulsifiers may be removed in the work up procedure, for example as described in WO03/051988.

The 3D-printable compositions may comprise one or more stabilizing surfactant. The surfactants may be fluorinated or non-fluorinated and preferably are non-fluorinated. Typically they are non-ionic or amphoteric. Preferred are emulsifiers that provide sufficient shear stability to the fluoropolymer dispersion but degrade or evaporate at the heat process in the work up procedure.

In one embodiment the 3D-printable compositions provided herein may contain one or more stabilizing emulsifiers. Optimum amounts may vary and depend on the binder material and ratio of binder material to fluoropolymer, foaming properties of surfactants, compatibility of the surfactants with the other ingredients, surface-activity of the surfactants and foaming properties of the surfactants because too much foaming may not be suitable. Typical amounts of stabilizing emulsifiers are 0.5 to 12% by weight based on the weight of the 3D-printable composition.

Examples of stabilizing emulsifiers include but are not limited to ethoxylated alcohols, amine oxide surfactants and ethxoyated amine surfactants as will be described in greater detail below.

Ethoxylated Alcohol Surfactants

Examples of non-ionic surfactants can be selected from the group of alkylarylpolyethoxy alcohols (although not preferred), polyoxyalkylene alkyl ether surfactants, and alkoxylated acetylenic diols, preferably ethoxylated acetylenic diols, and mixtures of such surfactants.

In particular embodiments, the non-ionic surfactant or mixture of non-ionic surfactants corresponds to the general formula:

R¹O—X—R³

wherein R¹ represents a linear or branched aliphatic or aromatic hydrocarbon group that may contain one or more catenary oxygen atoms and having at least 8 carbon atoms, preferably 8 to 18 carbon atoms. In a preferred embodiment, the residue R¹ corresponds to a residue (R′)(R″)C— wherein R′ and R″ are the same or different, linear, branched or cyclic alkyl groups. R³ represents hydrogen or a C₁-C₃ alkyl group. X represents a plurality of ethoxy units that can also contain one or more propoxy unit. For example, X may represent —[CH₂CH₂O]ₙ—[R²O]ₘ—R² represents an alkylene having 3 carbon atoms, n has a value of 0 to 40, m has a value of 0 to 40 and the sum of n+m is at least 2 and the units indexed by n and m may be arranged at random. Also mixtures of the above emulsifiers may be used. Commercially available non-ionic surfactants or mixtures of non-ionic surfactants include those available from Clariant GmbH under the trade designation GENAPOL such as GENAPOL X-080 and GENAPOL PF 40. Further suitable non-ionic surfactants that are commercially available include those of the trade designation Tergitol TMN 6, Tergitol TMN 100X and Tergitol TMN 10 from Dow Chemical Company.

Amine Oxide Surfactants

In one embodiment the 3D-printable composition may comprise one or more amine oxide surfactants. Such emulsifiers are described, for example, in U.S. Pat. No. 8,097,673 B2.
The amine oxide surfactants may correspond to the formula:

(R¹)(R²)(R³)N—O

wherein R′ is radical of the formula:

R⁴—(C═O)ₐ—X—(C═O)_{b}(CH₂)ₙ—

wherein R⁴ is a saturated or unsaturated, branched or unbranched, cyclic or acyclic, alkyl, hydroxyalkyl, ether or hydroxyether radical having 1 to 20 carbon atoms, X is an O, NH or NR⁵, a and b are 0 or 1 with the proviso that a+b=1, and n is 2-6;
wherein R² and R³ are independently selected from saturated or unsaturated, branched or unbranched, cyclic or acyclic, alkyl, hydroxyalkyl, ether or hydroxyether radical having 1 to 10 carbon atoms optionally substituted with halogen;
R⁵ is selected from saturated or unsaturated, branched or unbranched, cyclic or acyclic, alkyl, hydroxyalkyl, ether or hydroxyether radical having 1 to 10 carbon atoms optionally substituted with halogen or an N-oxylamino group; and
wherein that R² and R³ may be joined by a chemical bond to form a ring.

If R², R³, R⁴ and R⁵ have halogen substitutions, preferably halogen substitutions are limited such that no more than about 70% of the atoms attached to carbon atoms of the radical are halogen atoms, more preferably no more than about 50% are halogen atoms. Most preferably, R², R³ R⁴ and R⁵ are not halogen substituted.

If R⁵ is substituted with N-oxylamino, groups bonded to the nitrogen atom preferably have 1 to 10 carbon atoms.

In preferred surfactants, R¹ is a radical of the formula:

R⁴—(C═O)ₐ—X—(C═O)_{b}—(CH₂)ₙ

wherein comprises alkyl having 1-20 carbons, X is NH, a and b are 0 or 1 with the proviso that a+b=1, and n is 2-4;

In more preferred surfactants, R¹ is a radical of the formula:

R⁴—(C═O)ₐ—X—(C═O)_{b}—(CH₂)ₙ—

wherein R⁴ comprises alkyl having 5-20 carbon atoms, X is NH, a and b are 0 or 1 with the proviso that a+b=1, and n is 3.

R² and R³ in the formula:

(R¹)(R²)(R³)N→O

may be independently selected from saturated or unsaturated, branched or unbranched, cyclic or acyclic, alkyl or hydroxyalkyl radical having 1 to 4 carbon atoms.

In one embodiment R² and R³ in the formula above are each independently selected from alkyl or hydroxyalkyl radicals having 1 to 2 carbon atoms.

Specific examples include cocoamidopropyl dimethyl amine oxide, 2-ethylhexylamidopropyl dimethyl amine oxide, and octylamidopropyl dimethyl amine oxide.

Aminoxide surfactants are commercially available, for example, under the trade designation GENAMINOX from Clariant.

Ethoxylated Amine Surfactants

In another embodiment the 3D-printable compositions may contain one or more ethoxylated amine surfactants. Amine oxide surfactants are described, for example, in U.S. Pat. No. 4,605,773. Ethoxylated amine surfactants may correspond to the formula:

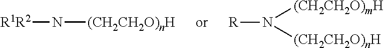

with R¹, R² and R being a non-polar residue, such as being independent from each other a branched, linear or cyclic alkyl, alkyloxy or polyoxy alkyl residue. Each non-polar residue may comprise, independent from each other, 4 or more, 6 or more, 8 or more and less than 30, more preferably more than 10 and less than 20, most preferably between 6 and 18 C atoms. In some embodiments one or more of the residues R¹, R² or R may be alkyl-substituted (preferably with a methyl or ethyl group) in the 1-position (that is, the position adjacent to the N-atom) or di-alkyl-substituted in the 1-position.

In both formulae above n and m represent an integer and being independently from each other 1, 2, 3, 4, 5, 6, 7, 8, 9, 10, 11, 12, 13 or 14 or 1 to 10, 1 to 6 or 1 to 4. Preferably, the sum of n and m may be less than 30, more preferably less than 25, most preferably less than 20. The sum of n and m may also be 2, 3, 4, 5, 8, 10, 12, 20 or 25.

The total number of C-atoms in the molecule may be less than 50 or less than 40 or less than 20.

In one embodiment one or more residues of the tertiary amine linked to the N-atom may correspond to the formula:

R′—(OCH₂—CR″H)ₓ—

with R′ being hydrogen, a branched, linear or cyclic alkyl or aryl residue and R″ being hydrogen or an alkyl group including, for example, a methyl, ethyl, propyl, isopropyl, or butyl group. Preferably, R′ is a methyl, ethyl, propyl or isopropyl group;
x represents an integer of from 1, 2, 3, or 1 to 10, 1 to 6 or 1 to 4.

In another embodiment, x is an integer from 1 to 10, R″ is H or CH3 and R′ is selected from the group consisting of H or straight or branched alkyls, such as methyl, ethyl, propyl, isopropyl etc.

Examples of readily available ethoxylated amines include but are not limited to those marketed under the tradename TRITON RW-Series by Dow Chemical Company, Midland, Mich., USA, such as for example TRITON RW-20, RW-50, RW-70, RW-100, RW-150, or under the trade designation GENAMIN from Clariant, Basel, Switzerland.

Other emulsifiers contemplated as suitable include sugar-based surfactants, such as glycoside surfactants and polysorbates such as described, for example, in WO2011/014715 A2 (Zipplies et al).

Fluoropolymer Blends

In one embodiment, the 3D-printable compositions comprise mixtures of fluoropolymers. For example, in one embodiment the composition comprises mixtures of different non-melt processable fluoropolymers, for example polymers of different molecular weight.

In another embodiment the 3D-printable compositions comprise a blend of one or more non-melt processable fluoropolymer and one or more melt-processable fluoropolymer. The weight ratio of melt processable fluorothermoplasts to non-melt-processable fluoropolymers may be from 1:1 to 1:1000, or from 1:2 to 1:100. The presence of melt processable fluoropolymers in blends with non-melt processable fluoropolymers may lead to a more rapid filling of voids created by the removal of the binder material. This may be advantageous as it may lead to more dense articles after or during a thermal removal of the binder material from the article.

In one embodiment the fluorothermoplasts used in the blends are PFAs. PFAs are copolymers of TFE and at least one perfluoro alkyl vinyl ethers (PAVE's), perfluoro alkyl allyl ethers (PAAE) and combinations thereof. Typical amounts of copolymers range from 1.7% to 10% wt. Preferably, the PFAs have a melting point between 280° C. and 315° C., for example between 280° C. and 300° C.

The fluorothermoplasts may be linear or branched, for example in case they contain HFP, or they may contain longer branches created by using branching modifiers in the polymerization as described, for example in WO2008/140914 A1.

Blends of fluoropolymers may be conveniently prepared by providing the polymers in the form of aqueous dispersions and then blending the dispersions. The resulting dispersion may be upconcentrated to remove water if necessary by thermal evaporation, ultrafiltration or other methods known in the art. The other ingredients of the 3D-printable composition may be added to the dispersion containing the fluoropolymer blends to provide the final 3D-printable composition.

Binder Material

The binder material is capable of binding the polymer particles to form a layer comprising the polymer particles (first and second polymer—if the latter is present) in a part of the composition that has been exposed to the energy source of the additive processing device.

In one embodiment the binder material melts or liquefies upon exposure to the energy source. Such binder materials typically are not polymerizable. Typically, such binder material is selected from hydrocarbons having a melting point above 40° C. and below the melting point of the first and second polymer, if present. In this embodiment the 3D-printable composition typically is provided as a solid composition in form of a powder or as extruded filaments. Suitable binder materials include organic materials, preferably polymers. Also, polymers that in a strict scientific sense do not melt but soften or become less viscous may be used. Typically, the meltable binder has a melting point or melting range within a temperature from about 40 to about 140° C. Organic materials are materials that have carbon-carbon and carbon-hydrogen bonds and the materials may optionally be fluorinated, i.e. one or more hydrogens may be replaced by fluorine atoms. Suitable materials include hydrocarbon or hydrocarbon mixtures and long chain hydrocarbon esters, hydrocarbon alcohols and combinations thereof and including their fluorinated derivatives. Examples of suitable materials include waxes, sugars, dextrins, thermoplastics other than first and second polymers having a melting point as described above, polymerized or cross-linked acrylates, methacrylates, and combinations thereof The waxes may be natural waxes or synthetic waxes. Waxes are organic compounds containing long alkyl chains, for example long chain hydrocarbons, esters of carboxylic acids and long chain alcohols and esters of long chain fatty acids and alcohols, sterols and mixtures and combinations thereof. Waxes also include mixtures of long chain hydrocarbons. The term “long chain” as used herein means a minimum number of 12 carbon atoms.

Natural waxes include beeswax. A major component of the beeswax is myricyl palmitate which is an ester of triacontanol and palmitic acid. Spermaceti occurs in large amounts in the head oil of the sperm whale. One of its main constituents is cetyl palmitate. Lanolin is a wax obtained from wool, consisting of esters of sterols. Carnauba wax is a hard wax containing myricyl cerotate.

Synthetic waxes include paraffin waxes. These are hydrocarbons, mixtures of alkanes usually in a homologous series of chain lengths. They may include saturated n- and iso-alkanes, naphthylenes, and alkyl- and naphthylene-substituted aromatic compounds. Also fluorinated waxes may be used in which case some hydrogen atoms are replaced by fluorine atoms.

Other suitable waxes can be obtained by cracking polyethylene or propylene (“polyethylene wax” or “polypropylene wax”). The products have the formula (CH₂)ₙH₂, where n ranges between about 50 and 100.

Other examples of suitable waxes include but are not limited to candelilla wax, oxidized Fischer-Tropsch wax, microcrystalline wax, lanolin, bayberry wax, palm kernel wax, mutton tallow wax, petroleum derived waxes, montan wax derivatives, oxidized polyethylene wax, and combinations thereof.

Suitable sugars include for example and without limitation, lactose, trehalose, glucose, sucrose, levulose, dextrose, and combinations thereof.

Suitable dextrins include for example and without limitation, gamma-cyclodextrin, alpha-cyclodextrin, beta-cyclodextrin, glucosyl-alpha-cyclodextrin, maltosyl-alpha-cyclodextrin, glucosyl-beta-cyclodextrin, maltosyl-beta-cyclodextrin, 2-hydroxy-beta-cyclodextrin, 2-hydroxypropyl-beta-cyclodextrin, 2-hydroxypropyl-gamma-cyclodextrin, hydroxyethyl-beta-cyclodextrin, methyl-beta-cyclodextrin, sulfobutylether-alpha-cyclodextrin, sulfobutylether-beta-cyclodextrin, sulfobutylether-gamma-cyclodextrin, and combinations thereof.

Suitable thermoplastics include for example and without limitation, thermoplastics having a melting point of no greater than 180° C., preferably no greater than 140° C. or no greater than 100° C. Examples may include polyethyleneterephthalate (PET), polylactic acid (PLA), polyvinyl chloride (PVC), polymethyl methacrylate (PMMA), polypropylene (PP), bisphenol-A polycarbonate (BPA-PC) and combinations thereof.

Suitable acrylates and methacrylates are for example cross-linked or polymerized acrlyates including urethane acrylates, epoxy acrylates, polyester acrylates, acrylated (meth)acrylics, polyether acrylates, acrylated polyolefins, and combinations thereof, or their methacrylate analogs.

Other example of suitable binders include but are not limited to binders comprising polymers and polymerized materials selected from, gelatines, celluloses, ethyl cellulose, hydroxyl ethyl cellulose, hydroxyl propyl cellulose, methyl cellulose, hydroxy propyl cellulose, cellulose acetate, hydroxybutylmethyl cellulose, hydroxyethyl cellulose, hydroxyethylmethyl cellulose, glycoses, fructoses, gylcogens, collagens, starches, partially fluorinated thermoplastic fluoropolymers and combinations thereof.

Preferably, the materials are of low molecular weight such that they easily degrade at elevated temperatures for example at temperatures below and including 200° C. and can be easily removed.

The non-polymerizable (meltable) binder material may be present, for example, as particles or may be present, for example, as coating on the polymer particles. Particle sizes of the binder particles include, for example, from 1 to 150 μm, preferably about 5 micrometers to about 50 micrometers, and most preferably about 10 micrometers to about 30 micrometers. In one embodiment these particle sizes are average particle sizes (number average, (D₅₀ or median. Such particle sizes can be determined by microscopy using particle analysing software or from pictures taken from samples by microscopes). Generally, the average particle size of the binder particles preferably is larger than that of the polymer particles, for example by a factor between 2 and 100, preferably 2 and 10.

The optimum amount of binder material may be determined by mainly two factors: first the amount of binder material should be high enough such that it allows the formation of layers of the desired dimensions, i.e. it has to be present in an effective amount. Secondly, the amount should be minimised with respect to the polymer content to minimise shrinking of the article during the working up process, to minimise the voids in the finished articles created during the removal step of the binder material. Since solid compositions are used, higher polymer concentrations may be used than in the liquid 3D printable compositions, for example a polymer content of up to 90% by weight or even up to 95% by weight (based on the weight of the composition). Typical amounts of binder material include but are not limited to amounts from about 5 to about 20%, from about 8 to about 18%, for example from about 10 to about 15% by weight based on the weight of the total composition.

Polymerizable Binder

Preferably the binder material is a reactive material, more preferably a polymerizable material. The polymerizable binder material is matched to the energy source of the 3D printer, or in case a polymerization initiator is used to the polymerization initiator, or both. The polymerization initiator may be activated by the energy source and in turn initiates the polymerization of the polymerizable binder material. The polymerizable binder material is matched to the energy source of the additive processing device (3D printer) or polymerization initiator, such that exposure of the 3D printable composition to the energy emitted from the energy source allows polymerization to proceed at appropriate speed in the part of the composition that has been exposed to the energy emitted from the energy source of the 3D printer. For example, if the energy source is UV light, the polymerizable binder has reactive groups that are activated by irradiation with UV-light to start the polymerization. Alternatively or additionally, the composition may contain a photoinitiator that is reactive to UV irradiation and the activated photoinitiator then activates the reactive groups in the polymerizable binder to set off the polymerization.

The structure and nature of the polymerizable binder material is not particularly limited unless the desired result cannot be achieved. Upon polymerization the polymerizable binder forms a network with the dispersed fluoropolymer particles resulting in a solidified or gelled composition with the fluoropolymer particles contained in the polymerized binder network. This composition already has the three-dimensional shape of the final article but may contain liquid (dispersing medium, for example water), and is referred to as “green body”. The optimum amount and type of polymerizable binder material may be determined taking into account the following: the amount of binder material preferably is high enough such that it allows to solidify in the areas where the layers are to be created, i.e. it is preferably present in an effective amount to allow the formation of solidified layers of the desired dimensions. Secondly, the amount of polymerized binder may be minimised with respect to the fluoropolymer content to minimise or avoid shrinking of the article during the working up process. Also, the formation of voids in the finished articles created during the removal of the polymerized binder material may be minimised or even avoided. Also, the stability of the fluoropolymer dispersion has to be considered and too high amounts of binder material may lead to premature coagulation of the fluoropolymer dispersion or solution. The binder material is capable to polymerize to form a solid or gel of sufficient strength to retain dimensional stability throughout the creation of the created object. However, the polymerized binder material should not be responsible for the dimensional stability of the finished article and can be removed (preferably thermally) during the work up procedure without the article becoming dimensionally unstable. The polymerizable binder material desirably polymerizes fast under the conditions in the additive processing machine.

Further, the polymerized binder thermally degrades at temperatures below the melting temperature of the fluoropolymer, preferably it can be combusted at such conditions.

Preferably, the polymerizable binder material is dissolved or dispersed in the 3D printable composition. In one embodiment, the polymerizable binder material is liquid. To dissolve or disperse the binder material organic solvents or dispersants may be used or an aqueous medium like water may be used. The organic solvents or dispersants are preferably inert and do not polymerize or react with the binder or polymerization initiator.

A suitable polymerizable binder material includes monomers, oligomers or polymers with polymerizable groups, preferably end groups, that preferably are liquid or that can be dispersed or dissolved in a liquid, for example water. The polymerizable end groups include groups reactive to electromagnetic irradiation by polymerization or that polymerize upon activation by polymerization initiators or a combination thereof.

Suitable polymerizable binder materials include compounds with polymerizable groups comprising one or more olefinic unsaturation. Examples include compounds with end or side groups comprising one or more ethylenic unit, ie. a carbon-carbon unsaturation. Examples include end groups comprising one or more of the groups selected from vinyl groups (e.g., H₂C═CX— groups), allyl groups (e.g., H₂C═CX—CX¹X²—), vinyl ether groups (e.g., H₂C═CHX—O—), allyl ether groups e.g., (H₂C═CX—CX¹X²—O—), and acrylate groups (e.g., H₂C═CH—CO₂—) and combinations thereof. In the formula X represents H, methyl, halogen (F, Cl, Br, I) or nitrile and X¹ and X² each independently represents H, methyl, halogen (F, Cl, Br, I) or nitrile. In a preferred embodiment, X² and X¹ are all H and X represents H or CH₃. Examples include but are not limited to ethylene groups, vinyl groups, allyl groups. Suitable polymerizable groups include but are not limited to end and side groups comprising one or more units corresponding to the general formula (I)-(VI):

H₂C═C(X)— (I)

H₂C═C(X)—O— (II)

H₂C═C(X)—CH₂—O— (III)

H₂C═C(X)—C(═O)—(IV)

H₂C═CX—CO₂— (V)

H₂C═C(X)—OC(O)— (VI)

Examples of polymerizable binder materials include mono acrylates and mono methacrylates, i.e. compounds with one end or side group comprising an acrylate group or methacrylate group (e.g. an H₂C═CX—CO₂— group where X is CH₃). Another example includes poly acrylates or poly methyl acrylates, i.e. compounds having more than one end and/or side groups comprising an acrylate or methacrylate group. Yet other examples include monomeric, oligomeric and polymeric acrylates. Oligomeric acrylates comprise from 1 up to 25 repeating monomeric units. Polymeric acrylates comprise more than 25 repeating units. Further, these compounds comprise at least one acrylate end or side group to qualify as polymerizsable acrylates. Examples of repeating units of such monomeric, oligomeric or polymeric acrylates include but are not limited to ethoxy (—CH₂CH₂—O—) units and propoxy (—C₃H₆O—) units as well as acrylate units and combinations thereof. Acrylates comprising an ethoxy unit are referred to also as “ethoxylated acrylates”.

Specific examples include ethoxylated or polyethoxylated acrylates, for example polyethylene glycols having one, two or three acrylic end or side groups. Other examples include acrylates having one or more than one acrylate group linked to an alkyl or alkylene chain that may be interrupted once or more than once by oxygen atoms. Acrylates include but are not limited to monoacrylates, diacrylates and triacrylates and combinations thereof including their methacrylic equivalents. Specific examples include but are not limited to exthoxylated triacrylates and diacrylates and the corresponding methacrylates. Specific examples include ethoxylated trimethylol propane triacrylates (SR415); polyethylene glycol dimethacrylate (SR252), polyethylene glycol diacrylate (SR344), ethoxylated bisphenyl A dimethacrylate (SR9036A), ethoxylated bisphenyl A dimethacrylate (SR9038) all commercially available from Sartomer Americas, Exton, Pa., USA.

In one embodiment of the present disclosure the binder material comprises a polyethylene glycol di- or triacrlyate or a combination of polylethlyene glycol di- and triacrylates.

The overall composition of the polymerizable material may be selected so that the polymerized material is liquid, or is soluble in a solvent or dispersing medium used in the 3D-printable composition, e.g. water. Further, the overall composition of the polymerizable material can be selected to adjust compatibility with the other ingredients of the 3D-printable composition or to adjust the strength, flexibility, and uniformity of the polymerized material. Still further, the overall composition of the polymerizable material can be selected to adjust the burnout characteristics of the polymerized material prior to sintering. Various combinations of binder materials may be possible and are available to the person skilled in the art. Mixtures of different polymerizable binder materials may be used. For example, bi- or polyfunctional polymerizable binder materials may be included that generate a cross-linked network. A successful build typically requires a certain level of green body gel strength as well as shape resolution. A crosslinked approach often times allows for greater green body gel strength to be realized at a lower energy dose since the polymerization creates a stronger network. The presence of monomers having a plurality of polymerizable groups tends to enhance the strength of the gel composition formed when the printing sol is polymerized. The amount of the monomer with a plurality of the polymerizable groups can be used to adjust the flexibility and the strength of the green body, and indirectly optimize the green body resolution and final article resolution.

In the following, exemplary binder materials are contemplated as being useful as an alternative to the materials described above or in combination with them.

Examples include but are not limited to acrylic acid, methacrylic acid, beta-carboxyethyl acrylate, and mono-2-(methacryloxyethyl)succinate. Exemplary polymerization hydroxyl-containing monomers for use as binder or for preparing binder compositions include hydroxyethyl acrylate, hydroxyethyl methacrylate, hydroxypropyl acrylate, hydroxypropyl methacrylate, hydroxyl butyl acrylate, and hydroxybutyl methacrylate. Acryloxy and methacryloxy functional polyethylene oxide, and polypropylene oxide may also be used as the polymerizable hydroxyl-containing monomers.

An exemplary radically polymerizable binder material comprises mono-(methacryloxypolyethyleneglycol) succinate.

Another example of a radically polymerizable binder material (activated by a photoinitiator) is a polymerizable silane. Exemplary polymerizable silanes include me thacryloxyalkyltrialkoxysilanes, or acryloxyalkyltrialkoxysilanes (e.g., 3-methacryloxypropyltrimethoxysilane, 3-acryloxypropyltrimethoxysilane, and 3-(methacryloxy)propyltriethoxysilane; as 3-(methacryloxy)propylmethyldimethoxysilane, and 3-(acryloxypropyl)methyldimethoxysilane); methacryloxyalkyldialkylalkoxysilanes or acyrloxyalkyldialkylalkoxysilanes (e.g., 3-(methacryloxy)propyldimethylethoxysilane); mercaptoalkyltrialkoxylsilanes (e.g., 3-mercaptopropyltrimethoxysilane); aryltrialkoxysilanes (e.g., styrylethyltrimethoxysilane); vinylsilanes (e.g., vinylmethyldiacetoxysilane, vinyldimethylethoxysilane, vinylmethyldiethoxysilane, vinyltrimethoxysilane, vinyltriethoxysilane, vinyltriacetoxysilane, vinyltriisopropoxysilane, vinyltrimethoxysilane, and vinyltris(2-methoxyethoxy)silane).

Exemplary monomers with two (meth)acryloyl groups include 1,2-ethanediol diacrylate, 1,3-propanediol diacrylate, 1,9-nonanediol diacrylate, 1,12-dodecanediol diacrylate, 1,4-butanediol diacrylate, 1,6-hexanediol diacrylate, butylene glycol diacrylate, bisphenol A diacrylate, diethylene glycol diacrylate, triethylene glycol diacrylate, tetraethylene glycol diacrylate, tripropylene glycol diacrylate, polyethylene glycol diacrylate, polypropylene glycol diacrylate, polyethylene/polypropylene copolymer diacrylate, polybutadiene di(meth)acrylate, propoxylated glycerin tri(meth)acrylate, and neopentylglycol hydroxypivalate diacrylate modified caprolactone.

Exemplary monomers with three or four (meth)acryloyl groups include, but are not limited to, trimethylolpropane triacrylate (e.g., commercially available under the trade designation TMPTA-N from Cytec Industries, Inc. (Smyrna, Ga., USA) and under the trade designation SR-351 from Sartomer (Exton, Pa., USA)), pentaerythritol triacrylate (e.g., commercially available under the trade designation SR-444 from Sartomer), ethoxylated (3) trimethylolpropane triacrylate (e.g., commercially available under the trade designation SR-454 from Sartomer), ethoxylated (4) pentaerythritol tetraacrylate (e.g., commercially available under the trade designation SR-494 from Sartomer), tris(2-hydroxyethylisocyanurate) triacrylate (e.g., commercially available under the trade designation SR-368 from Sartomer), a mixture of pentaerythritol triacrylate and pentaerythritol tetraacrylate (e.g., commercially available from Cytec Industries, Inc., under the trade designation PETIA with an approximately 1:1 ratio of tetraacrylate to triacrylate and under the trade designation PETA-K with an approximately 3:1 ratio of tetraacrylate to triacrylate), pentaerythritol tetraacrylate (e.g., commercially available under the trade designation SR-295 from Sartomer), and di-trimethylolpropane tetraacrylate (e.g., commercially available under the trade designation SR-355 from Sartomer).

Exemplary monomers with five or six (meth)acryloyl groups include, but are not limited to, dipentaerythritol pentaacrylate (e.g., commercially available under the trade designation SR-399 from Sartomer) and a hexa-functional urethane acrylate (e.g., commercially available under the trade designation CN975 from Sartomer).

Exemplary monomers for use as polymerizable binders include alkyl (meth)acrylates that have an alkyl group with a linear, branched, or cyclic structure. Examples of suitable alkyl (meth)acrylates include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, n-pentyl (meth)acrylate, 2-methylbutyl (meth)acrylate, n-hexyl (meth)acrylate, cyclohexyl (meth)acrylate, 4-methyl-2-pentyl (meth)acrylate, 2-ethylhexyl (meth)acrylate, 2-methylhexyl (meth)acrylate, n-octyl (meth)acrylate, isooctyl (meth)acrylate, 2-octyl (meth)acrylate, isononyl (meth)acrylate, isoamyl (meth)acrylate, 3,3,5-trimethylcyclohexyl (meth)acrylate, n-decyl (meth)acrylate, isodecyl (meth)acrylate, isobornyl (meth)acrylate, 2-propylheptyl (meth)acrylate, isotridecyl (meth)acrylate, isostearyl (meth)acrylate, octadecyl (meth)acrylate, 2-octyldecyl (meth)acrylate, dodecyl (meth)acrylate, lauryl (meth)acrylate, and heptadecanyl (meth)acrylate.

Optimum amounts of binder material may be adapted to the specific system used. Generally, suitable amounts of binder in the 3D-printable compositions include amounts from 1 to 50%, or from 2 to 25%, or from 10 to 20% (weight per cents based on the total weight of the compositions). The binder may have to be removed during the work-up procedure so the binder material should not be used in a great excess over the polymer particles as this may cause a structural failure of the article (in case a polymerizable binder is used the polymerized binder may have to be removed from the article). The binder material is used an effective amount to create the matrix forming the article.

Optimum ratios of polymer to polymerizable binder material depend on the type and nature of the binder material but may typically include, but are not limited to, weight ratios of polymer to polymerizable binder material of from 5:1 to 1:2, preferably from 4:1 to 1:1.

In some applications, it can be advantageous to minimize the weight ratio of binder material to polymer particles in the reaction mixture. This tends to reduce the amount of decomposition products of organic material that needs to be burned out prior to formation of the sintered article. The amount of binder may also depend on the speed at which the polymer particles sinter. If the sintering proceeds fast the combustion gases from the binder material get trapped inside the article, which can lead to a reduced density or to surface defects. In this case oxidation catalysts may be used or the amount binder may be reduced.

Preferably, the binder material, in particular polymerizable binder material, has a weight of from 100 to 5,000 g/mole or comprises polymerizable monomers or oligomers having a molecular weight from 100 to 5,000 g/mole. This facilitates the formation of a 3D-printable composition of a favourably low viscosity. Also, lower molecular weight polymerizable binder material may be better soluble in an aqueous dispersion than high molecular weight material.

Other exemplary polymerizable binder materials contemplated herein include materials with polymerizable groups including but not limited to epoxides, silanes and reactive components that can polymerize to form polyurethanes (e.g., hydroxyl groups, ester groups, isocyanate groups).

Other Additives

Polymerization Initiators

One or more polymerization initiators that initiate polymerization of the polymerizable binder material may be present in the 3D-printable composition. The polymerization initiator gets activated upon exposure to the energy source, for example, upon exposure to UV irradiation or e-beam irradiation, or heat. Initiators that are activated by irradiation with visible or invisible light are referred to as photoinitiators. Polymerization initiators may be organic or inorganic. Polymerization Initiators are known in the art and are commercially available. Preferably, the following classes of photoinitiator(s) can be used: a) two-component system where a radical is generated through abstraction of a hydrogen atom

form a donor compound; b) one component system where two radicals are generated by cleavage.

Examples of photoinitiators according to type (a) typically contain a moiety selected from benzophenone, xanthone or quinone in combination with an aliphatic amine.

Examples of photoinitiators according to type (b) typically contain a moiety selected form benzoin ether, acetophenon, benzoyl oxime or acyl phosphine.

Exemplary UV initiators include 1-hydroxycyclohexyl benzophenone (available, for example, under the trade designation “IRGACURE 184” from Ciba Specialty Chemicals Corp., Tarrytown, N.Y.), 4-(2-hydroxyethoxy)phenyl-(2-hydroxy-2-propyl) ketone (available, for example, under the trade designation “IRGACURE 2529” from Ciba Specialty Chemicals Corp.), 2-hydroxy-2-methylpropiophenone (available, for example, under the trade designation “DAROCURE D111” from Ciba Specialty Chemicals Corp. and bis(2,4,6-trimethylbenzoyl)-phenylposphineoxide (available, for example, under the trade designation “IRGACURE 819” from Ciba Specialty Chemicals Corp.).

In one embodiment of the present disclosure a polymerization initiator is used with a polymerizable binder material selected from acrylates. Typically, the polymerization initiator is a photoinitiator, which is activated by irradiation with visible or invisible light, preferably by UV irradiation. The optimum amounts of initiator depend on the system used. Typical amounts include but are not limited to amounts of 1 to 0.005 times the weight of the polymerizable binder used.

The photoinitiator should be able to start or initiate the polymerization of the polymerizable binder material. Typical amounts of photoinitiator(s) include but are not limited to the following amounts: Lower amount: at least 0.01 or at least 0.1 or at least 0.5 wt.-%; Upper amount: at most 0.5 or at most 1.5 or at most 3 wt.-%; Range: from 0.01 to 3 or from 0.5 to 1.5 wt.-%; wt.-% with respect to the weight of the 3D-printable composition.

Instead of polymerization initiators that are activated by visible or invisible light, like UV irradiation, it is also possible to use initiators that are activated thermally or by actinic irradiation. In such case, the energy source is appropriately selected to allow activation of the initiators.

Polymerization Inhibitors

The 3D-printable compositions may also contain one or more polymerization inhibitors, to help keeping the polymerization reaction localized to the areas that have been exposed to the energy source of the additive processing machine. Such polymerization inhibitors slow down the polymerization reaction or terminate it, for example by acting as radical scavengers. Inhibitors for polymerization with irradiation through light, including UV light are known in the art as “photoinhibitors” and include commercially available materials such as 2,6-di-tert-butyl-4-methylphenol, available from Sigma-Aldrich, St Louis, Mo., USA. Optimum amounts of inhibitors depend on the system of polymerizable binder material, initiators and energy source used. Typical amounts of inhibitors include but are not limited to amounts of from 0.9 to 0.001 times the amount of polymerization initiator (by weight).

Fillers, Pigments, UV Enhancers and Oxidation Catalysts

The 3D-printable compositions may further comprise fillers, pigments or dyes if compatible with the 3D printer used and the thermal work up treatment. Fillers may include but are not limited to silicon carbide, boron nitride, molybdenum sulfide, aluminum oxides, carbon particles, such as graphite or carbon black, carbon fibers, carbon nanotubes, solid or hollow glass microspheres. The filler content can be optimized to the system used and may typically be between 0.01 to 10% or up to 30% or even up to 50% by weight based on the total weight of the composition depending on the polymers and binder materials used. The fillers are preferably in particulate form and have sufficiently small particle size to allow for a homogeneous dispersion in the 3D-printable composition. To be compatible with the 3D-printable composition the filler particles advantageously have a particle size of less than 500 μm, preferably less than 50 μm or even less than 5 μm or less than 1 μm.

Pigments have to be heat-stable at the temperatures applied in the thermal work up procedures, i.e. at least the melting temperature of the first or second polymers.

Ingredients that increase the irradiation energy from the energy may also be included in the 3D printable composition. For example, by activation through UV irradiation UV enhancers (“optical brighteners”) may be included in the composition. These are chemical compounds that absorb light in the ultraviolet and violet region (usually 340-370 nm) of the, and re-emit light in the blue region (typically 420-470 nm) by fluorescence. A useful optical brightener is Benetex OB-M1. Lakefield ct. Suwanee, Ga. 30024. This UV brighteners may also help to limit the penetration of the irradiation from the energy source through the 3D-printable composition and to control the polymerization to localized areas.

Oxidation catalysts may also be included in the 3D-printable composition to accelerate the combustion of binder during the thermal work up procedure. This may help to create a smoother surface and to avoid the formation of surface defects. It is believed that when the combustion of the binder material is not completed when the surface particles fuse during a sintering step trapped combustion gases may lead to formation of microbubbles or micro cracks on the surface of the sintered article. The oxidation catalyst may accelerate the combustion such that the combustion gases have evaporated before the polymer particles on the surface might fuse. Oxidation catalysts are described for example in U.S. Pat. No. 4,120,608 and include cerium oxides or other metal oxides. Cerium oxide is commercially available from Nyacol Nano Technologies Inc.

Additive Processing of the 3D-Printable Compositions

The 3D-printable composition is entered into the additive processing machine (3D printer) and is subjected to additive processing to create a three-dimensional object containing first and second polymer (if present), binder and (if used) dispersing medium (for example water) or solvent. The optimum concentration may depend on the type and amounts of the other ingredients, for example the binder material, the polymers and the type of 3D printer used. Too high concentrations of fluoropolymer may lead to the formation of viscous compositions that may be difficult to process in some types of 3D printers, for example VAT polymerization or stereolithography. In that case, the fluoropolymer concentration could be lowered or the composition can be diluted, for example by adding water, solvent or another dispersing medium or other 3D-printing methods require more viscous compositions such as pastes, for example printers operating with paste extrusions.

Generally, the 3D-printable compositions include but are not limited to compositions with amounts of fluoropolymers, in particularly not melt-processable fluoropolymers, of from about 5% to 45%, 10% to 40%, or 15 to 35% (percent by weight, based on the total weight of the composition). Generally, the 3D-printable compositions include but are not limited to compositions with amounts of first polymers in particularly not melt-processable fluoropolymers, of from about 5% to 45%, 10% to 40%, or 15 to 35% (percent by weight, based on the total weight of the composition).

Generally, the 3D printable composition may include from 5 to 50% of binder material and from 0 to 70% by weight of water.

The total amount of the ingredients, however, will correspond to 100% by weight.

The weight ratio of first polymer to second polymer may be include ratios of from 9:1 to 1:9, preferably from 1:1 to 1:9; or from 1:2 to 1:8, or from 2:1 to 1:4 to 1:8. Minimum amounts of first polymer is 5% by weight based on the weight of the total composition, preferably at least 10% by weight.

In one embodiment the amounts are chosen that after binder removal and removal of dispersing medium if present, a composite material is formed containing from 55% to 95% or from 60 to 90% by weight of second polymer, preferably of not melt-processable fluoropolymer. In that embodiment the composite may contain from 5 to 45% by weight of first polymer, preferably a poylaryl ether ketone, preferably a PEEK

In one embodiment the amounts are chosen that after binder removal and removal of dispersing medium, if used, a composite material is formed containing from 55% to 95% or from 60 to 90% by weight of first polymer, preferably a polyaryl ether ketone, preferably a PEEK. In that embodiment the composite may contain from 5 to 45% by weight of second polymer, preferably of not-melt processable fluoropolymer.

After the additive manufacturing step the resulting article already has the overall shape of the final article but contains binder material and may also contain a dispersion medium that is not binder material, for example water or solvents. This article is referred to as “first green body”. The first green body may be removed from the 3D printer and may be separated from the unreacted composition. The unreacted composition may be discarded or reused. The resulting article contains the polymers and binder material. In case a polymerizable binder was used in the 3D-printable composition the article will contain polymerized binder. Therefore, in one embodiment of the present disclosure there is provided an article containing a first polymer (and optionally a shaped composite of first and second polymer) and binder material that is obtainable by additive processing as described herein.

This article (green body) may comprise from 10 to 50% by weight of the polymerizable or polymerized binder material. The article may further contain from 5 to 50% of dispersing medium including water and from 10 to 90% of first polymer or of first and second polymers as described herein. The weight percentages are based on the weight of the article (100%) and total amount of the ingredients of the article does not exceed 100%. The first green body can also be referred to as an “aquagel” if water was used as dispersing medium. The green body or aquagel has the same general shape as the final article (article after removal of the binder) but may be less dense and also less rigid and more porous.

Removal of Solvent or Dispersing Medium

The solvent or dispersing medium may have to be removed from the green body. This may be done by evaporating the solvent or dispersing medium, for example by evaporation at room temperature or evaporation during a heat treatment. For example, drying can be carried out at room temperature at elevated temperatures, or under vacuum and combinations thereof. Drying may be carried out with heated air or heated gases (for example butane or propane). Drying may also be carried out under controlled humidity for example under constant 50 to 90% humidity or under controlled decrease of humidity, for example from 90% to 50% over 24 hours. Freeze drying may also be used. Dielectric drying and drying by radiation (for instance microwaves being absorbed inside the material or drying by IR) may also be used. Dielectric drying and drying by radiation may be assisted by air drying or vacuum drying. Drying regimes may be selected that allow for slow and homogeneous removal of solvent/dispersing agent from the articles.

In case rather large amounts of water are present in the article, the removal of water can be done by solvent exchange where water is exchanged with a solvent that evaporates faster than water. Solvent exchange may be carried out by soaking the articles in the exchange solvent. This may have to be repeated several times.

Solvent or dispersing medium may in addition or as an alternative also be removed by a treatment (for example extraction) with a super critical fluid, preferably supercritical carbon dioxide (CO₂). Other supercritical fluids that may be used include but are not limited to methane, ethane, propane, ethene, propene, methanol, ethanol or acetone.

If the dispersing medium or solvent is not miscible with the supercritical fluid, the solvent or dispersing medium is exchanged with a solvent or solvent mixture that is miscible with the super critical fluid, typically prior to extraction with the supercritical fluid. The solvent exchange can be carried out by submerging the first green body into the exchange solvent for an extended period of time and then discarding the solvents. These steps may be repeated once or several times. Ex-change solvents include but are not limited to methanol, ethanol, isopropanol, methoxyethanol, β-ethoxyethanol, methoxypropanol, i-butyl alcohol, sec-butyl alcohol, amyl alcohol, hexanol, cyclohexanol, cyclohexane, heptane, dodecane, formic acid, acetic acid, hexanoic acid, isohexanoic acid, octanoic acid, acetaldehyde, acetic anhydride, acetone, acetonitrile, acetophenone, acetyl chloride, acrolein, acetonitrile, benzene, benzaldehyde, benzonitrile, benzoyl chloride, 2-butanone, n-butyl ether, camphor, carbon disulfide, carbon tetrachloride, chloroacetone, chlorobenzene, chloroform,

cyclohexanone, 1-decene, p-dichlorobenzene, diethylene glycol monoethyl ether, N,N-diethylacetamide, N,N-dimethylacetamide, N,N-dimethylformamide, N,N-diethylformamide, 2,2-dimethylpentane, p-dioxane, ethyl acetate, ethyl acetoacetate, ethyl benzoate, ethyl carbonate, ethyl chloroacetate, ethyl chloroformate, ethylene bromide, ethylene diformate, ethylene glycol monobutyl ether, ethyl ether, ethyl formate, ethyl lactate, ethyl maleate, ethyl oxalate, ethyl phenylacetate, ethyl salicylate, ethyl succinate, ethyl sulfate, furfural, 1-heptaldehyde, 2,5-hexanedione, indene, isopropyl ether, limonene, methyl acetate, methyl benzoate, methylcyclohexane, methyl formate, methyl salicylate, methyl sulfate, nitrobenzene, nitroethane, nitromethane, o-nitrophenol, nitrotoluene, 1-nitropropane, 2-octanone, thioxane, paraldehyde, pentanaldehyde, 2-picoline, pinene, propionaldehyde, pyridine, salicylaldehyde, thiophene, toluene, triacetin, tri-sec-butylbenzene, and 2,2,3-trimethylbutane.

Preferably, the exchange solvent is an alcohol (preferably an alkanoic alcohol), an ether alcohol or polyether alcohol, a polyol, polyether polyol or combinations thereof The exchange solvent preferably is aliphatic, more preferably aliphatic and non-halogenic.

For the treatment with a super critical fluid the article is typically placed in an autoclave. The fluid is pumped into the autoclave at a temperature above the critical temperature of the fluid and at pressure greater than the critical pressure of the fluid. Temperature and pressures required to keep the fluid in the super critical state are maintained in the autoclave for a time sufficient to complete the solvent exchange by pumping an additional quantity of the fluid into the autoclave and venting the mixture of supercritical fluid and solvent/dispersion medium to a separator vessel and releasing the pressure. When the extraction is completed or terminated the pressure is released and the supercritical fluid can be removed or released.

A supercritical fluid is a substance at a temperature and pressure above its critical point, where distinct liquid and gas phases do not exist. The critical point (or critical state) is the end point of a phase (liquid-vapor) equilibrium curve that designates conditions under which a liquid and its vapor can coexist. At the critical point, defined by a critical temperature T_{c} and a critical pressure p_{c} phase boundaries vanish. Extraction conditions for CO₂ are above the critical temperature of 31° C. and critical pressure of 74 bar. Further information on the principles and practice of super critical extraction can be found, for example, in van Bommel, M. J., and de Haan, A. B. J. Materials Sci. 29 (1994) 943-948, Francis, A. W. J. Phys. Chem. 58 (1954) 1099-1114 and cHugh, M. A., and rukonis, V. J. Supercritical Fluid Extraction: Principles and Practice. Stoneham, Mass., Butterworth-Heinemann, 1986, incorporated herein by reference.

Removal of Binder

After removal of solvent or dispersing medium like water, the resulting article contains less or no dispersing medium or solvent but may still contain (polymerized) binder material.

Such article may be referred to as second green body. Such articles have the same overall shape of the green body obtained after solvent removal or removal of dispersing medium. Such articles may comprise from 10 to 35% by weight of the polymerizable or polymerized binder material. The article may further contain from 0 to 5% of dispersing medium including water and from 10 to 90% of first polymer or of first and second polymers as described herein. The weight percentages are based on the weight of the article (100%) and total amount of the ingredients of the article does not exceed 100%.

The binder material (polymerized or unpolymerized) may be removed from the article in a separate heating regime or parallel to the drying regime for removal of solvent/dispersing medium. Conveniently this is carried out by a heat treatment to degrade (for example by oxidization or combustion) and/or evaporate polymerized or unpolymerized binder material. The temperatures are typically chosen such that the binder material is removed but the structural integrity of the article is not impacted, i.e. the article does not melt or gets destroyed. In case of composite materials, the temperatures and materials are chosen that the polymer that is present in major amounts may form the continuous phase of the composite material and the polymer that is present in minor amounts may form the dispersed case, for example may be present in the form of small particles.

The heat treatment may involve sintering, which means the article is heated above the melting point of the polymer. Sintering may be carried out for not melt-processable fluoropolymers, in particular when present in major amounts and when forming the major phase. Because of the high melt viscosity of the material, heating above the melting point may not change the overall structure of the article. Preferably, sintering is carried out in a subsequent heat treatment step. In an additional heating step the temperature may be raised to the melting temperature of the first or second polymer or above (“sintering”). At such temperatures the polymer particles might fuse but because of the high melt-viscosity of the polymers the article will retain its overall shape. Sintering may involve a heat treatment of up to 20° C., up to 40° or even up to 60° C. or even higher than 60° C. above the melting point of the polymers, in particular the fluoropolymers, may be carried out in the sintering step.

The heat treatment may be carried out below the melting point of the first polymer or above the melting point of the first polymer, in particular when the first polymer is present in minor amounts, which means in amounts below 50% by weight, preferably below 35% by weight.

Binder burn-out and sintering can be controlled such that the binder material does not completely burn off and residual amounts remain in the article, which may be desired for some applications. The presence of residual degraded binder material may add some properties to the article that may be desirable for particular applications. Heating (burn out) and sintering conditions may vary depending on the structure and composition of the articles. The number of discrete heating steps, temperatures, duration of heating periods and number of heating intervals can be optimized by routine experimentation.

The final article typically has the same shape as the green body, although some shrinking compared to the green body may be observed. By doing controls and test runs the amount of shrinking can be taken into account when programming the additive processing machine.

Articles

By the methods provided herein shaped articles containing the first polymer may be created. The shaped articles may contain one or more fillers or one or more other ingredients. In one embodiment the shaped articles comprise from 50 to 100% by weight of the first polymer, or from 55 to 95% by weight of the first polymer.

By the methods provided herein also shaped composite articles containing first and second polymer can be provided. The shaped articles may contain from 50 to 100% or from 55% to 95% of first and second polymers. In one embodiment the articles comprise from 5 to 40% by weight of the first polymer and from 95 to 60% by weight of the second polymer. In another embodiment the articles comprise from 90 to 60% by weight of the first polymer and from 40 to 10% by weight of the second polymer. The articles may further contain from 1 to 20% by weight of other ingredients, for example fillers. The total amounts of first and second polymers and the other ingredients in the composition is such that it adds up to 100% by weight.

It is an advantage of the methods and compositions of the present disclosure that the first polymers and also composite materials of first and second polymers can be shaped into articles having geometries and designs that could not be produced by machining with shaping tools. This includes integral articles comprising an essentially hollow structure. Hollow structures can be prepared by machining but only to some extent. Usually hollow structures are prepared in several steps and separate parts are joined, for example by welding. This leaves a seam (for example a weld seam) or a bond line visible to the naked eye. “Integral articles” as used herein do not have joint parts or an interface where two or more parts have been joint together. They do not have a seam or a bond line. With the 3D-printable compositions provided herein integral articles with complex geometries can be prepared. Examples include but are not limited to integral and essentially hollow articles. “Essentially hollow articles” as used herein are articles that comprise a hollow structure or a hollow component, for example, but not limited to, a hollow sphere, a cylinder, a cube, or a pyramid that has a continuous or an essentially continuous surface. An “essentially continuous surface” as used herein contains one or more apertures penetrating the surface. Preferably, less than 40% or less than 30%, more preferably less than 10% or less than 1% of the surface area of the continuous surface is interrupted by one or more apertures penetrating through the surface into the hollow part. Other structures that are difficult or even impossible to produce by conventional machining include honeycomb structures without weld seams. Further examples include integral articles with one or more undercuts, for example integral articles having one or more opening or aperture but further contain one or more undercuts at the inner side of the opening or aperture or behind the opening or aperture.

Articles and in particular composite articles of first and second polymers of big and small dimensions may be produced. The size of the additive processing device may set a limitation to the size of the articles that can be produced.

Articles of small dimensions may be produced by the methods described herein. For example, articles may be prepared including those having a longest axis (as the case may be this may also be a diameter) that is smaller than 1.0 cm or even smaller than 0.7 mm. In one embodiment small articles may be produced having a longest axis or diameter of from about 0.01 to about 1.0 mm, or from 0.7 to 1.5 cm.

Larger articles may also be produced with the methods provided herein, for example, but not limited to articles having a smallest axis or diameter of at least 1.1 mm. The present methods are also useful for making larger articles including articles having a longest axis (as the case may be this may also be a diameter) that is greater than 1.0 cm or even greater than 10 cm or greater than 20 cm (for example, but not limited to, articles having a longest axis or diameter of from 1.0 to 50 cm).

The methods provided herein may be useful for making articles having one or more than one internal or external walls with a thickness of at least 1 mm, preferably at least 2 mm, for example but not limited to wall thicknesses between 1.1 mm and 20 cm. The articles may have one or more internal or external walls having different thicknesses. An internal wall is a structure in the article that divides the space in the article. The wall typically has a length and a height and a width. The width is the dimension that is smaller than the length and the height of the wall. The thickness of the wall corresponds to the width of the wall. An external wall may be a circumferential wall of the article.

Articles may be prepared that have at least one element or part of a defined geometrical shape. Defined geometrical shapes include but are not limited to circles, semicircles, ellipses, half-spheres, squares, rectangles, cubes, polygons (including but not limited to triangles hexagons, pentagons, and octagons) and polyhedrons. The shapes include pyramids, cuboids, cubes, cylinders, half-cylinders, spheres, half-spheres. The shapes also include shapes composed of different shapes like diamonds (combination of two triangles). For example, a honeycomb structure contains several hexagons as geometrical elements. In one embodiment the geometrical shape has an axis or diameter of at least 0.5 millimetres, or at least one millimetre or at least 2 millimetres or at least one centimeter.

The articles of components thereof may contain one or more than one channels, perforations, honeycomb structures, essentially hollow structures and combinations thereof. Such structures may be flat, curved or spherical.

Examples of articles include but are not limited to bearings, for example friction bearings or piston bearings, gaskets, shaft seals, ring lip seals, washer seals, 0-rings, grooved seals, valves and valve seats, connectors, lids and containers. The articles may be chemical reactors, screws, actuators, cogwheels, joints, bolts, pumps, mixers, turbines, electrical transformers, electrical insulators, extruders or the articles may be components of other articles including the above articles. The articles may be used in application where resistance to acids, bases, fuels, hydrocarbons is required, where non-stick properties are required, where heat resistance is required and combinations thereof. The articles may be used in application where biological fluids are transported. The articles may be used in applications where such articles are exposed to hydrocarbon fuels or biological fluids.

Composites

With the compositions and methods of the present disclosure composite materials and composite articles of homogeneous distribution of polymer particles in the polymer phase of the other polymer. The homogeneous distribution may be seen by a narrow particle size distribution in the matrix, in particular of the second polymer particles, for example particle populations where the diameter of the particles of the second polymer is not greater than 100%, preferably not greater than 50%, or not greater than 20%, and preferably less than 10% of the average particle diameter (number average, median) of the population, in particular for an average particle size of from 0.5 to 15 μm. This can also or alternatively be seen by small average particle size of the polymer particles. For example, the average particle sizes of the polymer particle in the polymer phase made up by the other polymer of the polymer-polymer composites. Typically, the polymer that is present in greater amounts than the other polymer forms a continuous polymer phase on the other polymer is dispersed therein with small particles.

For example, composite materials of first and second polymers can be prepared wherein the second polymer particles are dispersed in the first polymer. Particles sizes of the second polymer include average particle sizes of less than 50 μm, preferably less than 25 μm or even less than 15 μm or less than 10 μm or even less than 5 μm. Preferably the second polymer is a not melt-processable fluoropolymer, for example a PTFE. Preferably, the amount of the second polymer is from 10 to 40%. Preferably, the continuous phase is a poly aryl ether ketone, more preferably a PEEK. For example, the average particle sizes of the second polymer particles, in particular PTFE polymers can be less than 40 μm, preferably less than 15 μm or even less than 10 μm or less than 8 μm for amounts of second polymer in the composite of from 5 to 45 wt % based on the total weight of the composite, from 95 to 65% by weight of first polymer and from 5 to 15% by weight of second polymer (based on the total weight of composite).

In embodiments where the continuous polymer phase is formed by the second polymer, the polymer particles of the first polymer may have homogeneous particle size distribution as described above or alternatively or in addition small average particle sizes, for example average particle sizes of less than less than 50 μm, preferably less than 25 μm or even less than 15 μm or less than 10 μm or even less than 5 μm. In particular for contents of first polymers of from about 5 to 45% by weight based on the weight of the composite material, for example composites containing from 5 to 45% by weight of first polymer and from 95 to 35% by weight of second polymer. Preferably, the first polymer is a polyaryl ether ketone, more preferably a PEEK. Preferably the second polymer is not melt-processable, more preferably a PTFE.

Particle size distributions can be determined by microscopy (SEM) and image analysis (for example for a particle count of 100 particles) using ×500 magnification or a ×800 magnification. In one embodiment the composite material contains from 55% to 95% or from 60 to 90% by weight of second polymer, preferably of not melt-processable fluoropolymer. In that embodiment the composite may contain from 5 to 45% by weight of first polymer, preferably a poylaryl ether ketone, preferably a PEEK

In one embodiment the composite material contains from 55% to 95% or from 60 to 90% by weight of first polymer, preferably a polyaryl ether ketone, preferably a PEEK. In that embodiment the composite may contain from 5 to 45% by weight of second polymer, preferably of not-melt processable fluoropolymer.

Due to the more homogeneous distribution of the polymer particles of one polymer in the continuous phase made up by the other polymer the composite materials may have improved mechanical properties, for example tensile strength before break.

The composite materials provided herein may also be shaped into articles or other articles by conventional methods.

The disclosure will now be further illustrated by a list of particular exemplary embodiments. This list of embodiments is intended to further illustrate the present disclosure and it is not intended to limit the present disclosure to the particular embodiments listed.

### List of Exemplary Embodiments

1. A 3D-printable composition wherein the composition comprises particles of a first polymer, particles of a second polymer and at least one binder material capable of binding the polymer particles to form a layer comprising the particles in a part of the composition that has been exposed to the energy source of the additive processing device and wherein the first polymer is selected from polymers having a melting point above of at least 250° C. or a glass transition temperature (Tg) of greater than 70° C. and wherein the first polymer is not a fluoropolymer and wherein the second polymer is a fluoropolymer.
2. The composition of embodiment 1 wherein the first polymer is selected from polymers having a melting point above of at least 320° C.
3. The composition of any one of the preceding embodiments wherein the first polymer has a glass transition temperature (Tg) of greater than at least 90° C.
4. The composition of any one of the preceding embodiments wherein the first polymer is selected from the group consisting of polyaryl ether ketones (PAEK), polyphenylene sulfide (PPS), polyphenylene sulfones (PPSO2), polyamides (PA), polyimides (PI), polyamide imides (PAI), and polyether imides (PEI).
5. The composition of any one of the preceding embodiments wherein the first polymer comprises a polymer selected from polyether ketones (PEK), polyether ether ketones (PEEKs), polyether ketone ketones (PEKKs), polyether ether ether ketones (PEEEKs), polyether ether ketone ketones (PEEKKs), and polyether ketone ether ketone ketones (PEKEKK).
6. The composition of of any one of the preceding embodiments wherein the second polymer is fluoropolymer is selected from the group consisting of tetrafluoroethylene homopolymers, tetrafluoroethylene copolymers containing up to 1% by weight of perfluorinated alpha-olefin comonomers, and tetrafluoroethylene copolymers containing more than 1% by weight and up to 30% by weight based on the weight of the polymer of perfluorinated comonomers, partially fluorinated comonomers and non-fluorinated comonomers.
7. The composition of any one of the preceding embodiments wherein the second polymer is a fluoropolymer having a melt flow index at 372° C. and 5 kg load (MFI 372/5) of less than 1 g/10 min.
8. The composition of any one of the preceding embodiments wherein the second polymer is a fluoropolymer having a melt flow index at 372° C. and 5 kg load (MFI 372/5) of less than 0.1 g/10 min.
9. The composition of any one of the preceding embodiments wherein the second polymer is a fluoropolymer having a melt flow index at 372° C. and 5 kg load (MFI 372/5) of from 1 to 50 g/10 min.
10. The composition of any one of the preceding embodiments wherein the second polymer is a fluoropolymer that is a tetrafluoroethylene copolymer containing more than 1% by weight and up to 30% by weight based on the weight of the polymer of perfluorinated comonomers, partially fluorinated comonomers and non-fluorinated comonomers and wherein the fluoropolymer has a melting point between 260° C. and 315° C.
11. The composition of any one of the preceding embodiments wherein the binder material is polymerizable and capable of binding the polymer particles to form a layer comprising the polymer particles by polymerizing in a part of the composition that has been exposed to the energy source of the additive processing device.
12. The composition of any one of the preceding embodiments wherein the binder material comprises polymerizable groups selected from acrylates and methacrylates.
13. The composition of any one of the preceding embodiments wherein the binder material has a molecular weight of less than 5,000 g/mole.
14. The composition of any one of the preceding embodiments 1 to 10 wherein the binder material is capable of binding the polymer particles to form a layer comprising the polymer particles in a part of the composition that has been exposed to the energy source of the additive processing device by melting upon exposure to the energy source.
15. The composition of any one of the preceding embodiments 1 to 10 wherein the binder material is capable of binding the polymer particles to form a layer comprising the polymer particles in a part of the composition that has been exposed to the energy source of the additive processing device by melting upon exposure to the energy source and wherein the binder material is selected from hydrocarbons having a melting point above 40° C., preferably above 60° C. and degrade (combust) at a temperature below the melting point of the first polymer and second polymer.
16. The composition of any one of the preceding embodiments wherein the composition is a dispersion and wherein at least the particles of the second polymer are dispersed in a dispersing medium.
17. The composition of any one of the preceding embodiments wherein the composition is a dispersion and wherein at least the particles of the second polymer are dispersed in a dispersing medium and the dispersing medium comprises water.
18. The composition of any one of the preceding embodiments wherein the composition is a dispersion and wherein the particles of the first and the second polymer are dispersed in a dispersing medium and the dispersing medium comprises the binder material.
19. The composition of any one of the preceding embodiments wherein the composition is an extrudable paste.
20. The composition of any one of the preceding embodiments wherein the particles of the first polymer have an average particle size from about 50 to 5,000 nm, preferably from 50 nm to 1,000 nm, more preferably from 50 to 600 nm (ISO 13321 (1996)).
21. The composition of any one of the preceding embodiments wherein the first polymer has a melt viscosity of at least 0.10 kNsm⁻² at 60 sec⁻¹ at 390° C. (ASTM D3835).
22. The composition of any one of the preceding embodiments wherein the particles of the second polymer have an average particle size of less than 2,000 nm, preferably from about 50 nm to 1.500 nm, more preferably from 50 nm to 1,000 nm and most more preferably from 50 nm to 500 nm (ISO 13321 (1996)).
23. Method of producing polymer articles comprising
(i) subjecting a composition according to any one preceding embodiments 1 to 22 to additive processing in an additive processing device containing at least one energy source;
(ii) subjecting at least a part of the composition to exposure of the energy source to form a layer comprising the polymer particles and binder material;
(iii) repeat step (ii) to form a plurality of layers to create an article.
24. The method of embodiment 23 further comprising (iv) at least partially removing binder material from the article.
25. The method of embodiment 23 or 24 wherein the composition is a dispersion comprising a dispersion medium and wherein the method further comprises removing the dispersion medium.
26. An article obtainable by the method of embodiment 23, wherein the article comprises a shaped composition comprising from about 5% to 35% by weight of binder material, from 10% to 80% by weight of the first polymer and from 10 to 80% by weight of a the second polymer and from 0 to 15% by weight of water and from 0% to 30% by weight of other ingredients, wherein the total amounts of ingredients is 100% by weight.
27. The article of embodiment 26 wherein the binder material is polymerized
28. The article of embodiment 26 or 27 wherein the binder material comprises polymerized groups selected from acrylates and methacrylates.
29. The article of any one of embodiments 26 to 28 wherein the binder material is selected from hydrocarbons having a melting point above 40° C., preferably above 60° C.
30. The article of any one of embodiments 26 to 29 wherein the composition is a dispersion and wherein at least the particles of the second polymer are dispersed in the binder material.
31. A composite material obtainable by the methods according to embodiments 24 or 25 comprising more than 50% of a second polymer and up to 49% of a first polymer and wherein the average particle sizes of the first polymers is less than 50 μm, preferably less than 25 μm or even less than 15 μm or less than 10 μm or even less than 5 μm.
32. The composite material of embodiment 31 where the first polymer is a polyaryl ether ketone, preferably a PEEK.
33. The composite material of embodiment 31 or 32 wherein the second polymer is not melt-processable.
34. A composite material obtainable by the methods of embodiments 24 or 25 comprising more than 50% of a first polymer and up to 49% of a second polymer and wherein the average particle sizes of the second polymer is less than 50 μm, preferably less than 25 μm or even less than 15 μm or less than 10 μm or even less than 5 μm
35. The composite material of embodiment 34 where the first polymer is a polyaryl ether ketone, preferably a PEEK.
36. The composite material of embodiment 34 or 35 wherein the second polymer is not melt-processable.
37. An article comprising the composite material of any one of embodiments 31 to 36.

In the present disclosure there is also provided a method of creating a computer-readable three-dimensional model suitable for use in manufacturing the article of embodiment 37 or the article of embodiments 26 to 30, the method comprising:

(a) inputting data representing the article to a computer; and

(b) using the data to represent the article as a three-dimensional model, the three-dimensional model being suitable for use in manufacturing the article.
The inputting of data includes at least one of (a) using a contact-type 3D scanner to contact the article, (b) using a non-contact 3D scanner to project energy onto the article and receive reflected energy, and (c) generating a virtual three-dimensional model of the article using computer-aided design (CAD) software.

In the present disclosure there is also provided a computer-readable three-dimensional model suitable for use in manufacturing the articles of embodiments 37, and 26 to 30.

In the present disclosure there is also provided a computer-readable storage medium having data stored thereon representing a three-dimensional model suitable for use in manufacturing the article of embodiments 37, and 26 to 30.

The disclosure will now be further illustrated by examples and test methods without intending the disclosure to be limited to the tests and examples below.

### Test Procedures

### Mechanical Properties:

Mechanical properties (tensile and elongation at break) were measured according to ASTM 1708 at 12.7 mm per minute extension.

### Melt Flow Index (MFI):

Melt flow index can be measured with a melt indexer (from Göttfert, Werkstoffprüfmaschinen GmbH, Germany) according to DIN EN ISO 1133 using a 5 kg load and a temperature of 372° C. (MFI 372/5).

### Average Particle Size:

Average particle size of polymer particles in a dispersion can be measured by electronic light scattering using a Malvern Autosizer 2c in accordance with ISO 13321 (1996). Particle sizes of solid particles can be analyzed by microscopy and imaging software using the number average (median) as average.

### Solid Content:

The solid content (polymer content) of the dispersions can be determined gravimetrically according to ISO 12086. A correction for non-volatile inorganic salts was not carried out.

### Melting Point:

Melting points can be determined by DSC (a Perkin Elmer differential scanning calorimeter Pyris 1) according to ASTM D 4591. 5 mg samples are heated at a controlled rate of 10° C./min to a temperature of 380° C. by which the first melting temperature is recorded. The samples are then cooled at a rate of 10° C./min to a temperature of 300° C. and then reheated at 10° C./min to a temperature at 380° C. The melting point observed at the second heating period is referred to herein as the melting point of the polymer (melting point of the once molten material).

### Density of Fluoropolymers:

The density was determined following ASTM D792-13 method A was used but using n-butyl acetate instead of water (and accordingly for the calculation the density of n-butyl acetate at 23° C. was used instead of the density of water at 23° C.). The method can be applied to shaped (and sintered) fluoropolymers and shaped compositions. Samples were taken as obtained, or samples were cut out from an article to determine the density of the composition making up the article.

The SSG density was determined following the procedure of ASTM D4895-15 method A. The SSG density can be used to characterize fluoropolymers used as raw materials or non-sintered fluoropolymers.

### Glass Transition Temperature:

The glass transition temperature (Tg) can be measured according to ASTM 3418.

### Heat Deflection Temperature:

The heat deflection temperature can be measure under a load of 0.45 MPa according to ASTM D648.

### TR-10:

The temperature reflection temperature (TR-10) can be measured according to ASTM D 1329.

### EXAMPLES

3D-printable compositions were made by weighing PTFE dispersion (PTFE: solid content 58% wt, average particle size: 190 nm, fluorinated emulsifier below 50 ppm, 6% based on PTFE content of non-ionic aliphatic stabilizing emulsifier; or modified PTFE (mPTFE, TFE+1,000 ppm PPVE) into a bottle and then agitating by lab bottle roller. Water and the PEEK dispersion (VICOTE F814 from Victrex plc) was added. In a separate bottle the binder material (acrylates SR415 from Sartomer Americas, Exton, Pa., USA, and SR433 from Sartomer Americas, Exton, Pa., USA and water were mixed and subsequently photo initiator (BHT from Sigma-Aldrich, St Louis, Mo., USA and TPO-L (ethyl (2,4,6-trimethylbenzoyl) phenyl phosphinate) and optical brightener (Benetex OB-M1 from Mayzo, Inc. Suwanee, Ga., USA were weighed, added, and then agitated by lab bottle roller. Upon complete mixing, the binder mixture was added slowly to the dispersion and the combined solution to form a complete printable formulation which was then agitated by lab bottle roller for a minimum 30 minutes prior to use. The printable formulation was stored in its bottle under continuous rolling until it was poured into the printer vat. The amounts of ingredients used are shown in table 1.

TABLE 1

| | C1 | C2 | C3 | C4 |
|---|---|---|---|---|
| Material | Wt (g) | Wt (g) | Wt (g) | Wt (g) |
| SR 415 | 7 | 7 | 7 | 7 |
| SR 344 | 7 | 7 | 7 | 7 |
| DI Water | 8.8 | 2.1 | 8.8 | 11.05 |
| PTFE dispersion | 60 | 48 | 0 | 0 |
| mPTFE dispersion | 0 | 0 | 60 | 64 |
| VICOTE F814 | 31.2 | 49.9 | 31.2 | 24.95 |
| TPO-L | 0.288 | 0.288 | 0.288 | 0.288 |
| BHT | 0.1152 | 0.1152 | 0.1152 | 0.0576 |
| OB-M1 | 0.0576 | 0.0576 | 0.0576 | 0 |

The printable solution was poured into a clean vat and the printer (ASIGA PICO 2 HD SLA type 3D printer with a 385nm DLP projector to illuminate each layer) was equipped with a roughened glass build plate. Articles in the shape of buttons (about 10 mm diameter, 1 mm height) were printed. Aquagels in the shape of buttons were formed on the printer from the network created from the polymerized binder and the water along with the dispersed particles. This highly crosslinked network binds the dispersion particles within it and retains them throughout the various post processing steps.

Following each print, the aquagel samples were rinsed in deionized water to remove uncured composition, residual surface liquids blown off by light pressurized nitrogen gas stream, and post cured under UV light for 30 seconds (Dymax light curing system Model 2000 Flood with a 400 Watt EC power supply).

The aquagels were then allowed to dry at room temperature for 30 hours. The dried aquagels were then transferred to an oven to thermally remove/decompose the binder material. Burn out of the binder was carried out in an oven (Despatch Industries Model: RAF 1-42-2E SN # 192066). A heating program was run containing several heating periods at 225°, 275° C., 325° C. and 380° C.

The resulting button-shaped articles were analyzed by microscopy (SEM utilizing Energy Dispersive Spectroscopy (EDS) and Backscattered Electron Imaging (BSEI). Samples were taken by breaking the sample under liquid nitrogen and images were taken a 500× or 800× magnification. The composite material showed a very homogeneous dispersion of polymer particles (PEEK particles) in a polymer matrix (fluoropolymer matrix). Average particle size was less than 10 μm.

1. A method of producing polymer articles comprising
(i) subjecting a composition to additive processing in an additive processing device containing at least one energy source wherein the composition comprises particles of a first polymer, particles of a second polymer and at least one binder material capable of binding the polymer particles to form a layer in a part of the composition that has been exposed to the energy source of the additive processing device;
(ii) subjecting at least a part of the composition to exposure of the energy source to form a layer comprising the polymer particles and binder material; and
(iii) repeating step (ii) to form a plurality of layers to create an article; and wherein the first polymer is selected from polymers having a melting point above of at least 250° C. or a glass transition temperature (Tg) of greater than 70° C. and is not a fluoropolymer and wherein the second polymer is a fluoropolymer;
wherein the binder material is polymerizable and capable of binding the polymer particles to form a layer comprising the polymer particles by polymerizing in a part of the composition that has been exposed to the energy source of the additive processing device; or
the binder material is capable of binding the polymer particles to form a layer comprising the polymer particles in a part of the composition that has been exposed to the energy source of the additive processing device by melting upon exposure to the energy source.

2. The method of claim 1, wherein the first polymer is selected from the group consisting of polyaryl ether ketones (PAEK), polyphenylene sulfide (PPS), polyphenylene sulfones (PPSO2), polyamides (PA), polyimides (PI), polyamide imides (PAI), and polyether imides (PEI) and combinations thereof, and wherein the group of polyaryl ether ketones (PAEK) comprises the group consisting of polyether ketones (PEK), polyether ether ketones (PEEKs), polyether ketone ketones (PEKKs), polyether ether ether ketones (PEEEKs), polyether ether ketone ketones (PEEKKs), and polyether ketone ether ketone ketones (PEKEKK) and combinations thereof.

3. The method of claim 1, wherein the second polymer is a fluoropolymer selected from the group consisting of tetrafluoroethylene homopolymers, tetrafluoroethylene copolymers containing up to 1% by weight of perfluorinated alpha-olefin comonomers, and tetrafluoroethylene copolymers containing more than 1% by weight and up to 30% by weight based on the weight of the polymer of perfluorinated comonomers, partially fluorinated comonomers and non-fluorinated comonomers.

4. The method of claim 1, wherein the binder material is polymerizable and capable of binding the polymer particles to form a layer comprising the polymer particles by polymerizing in a part of the composition that has been exposed to the energy source of the additive processing device.

5. The method of claim 1, wherein the binder material is capable of binding the polymer particles to form a layer comprising the polymer particles in a part of the composition that has been exposed to the energy source of the additive processing device by melting upon exposure to the energy source.

6. The method of claim 1, wherein the composition is a dispersion and wherein at least the particles of the second polymer are dispersed in a dispersing medium and wherein the method further comprises at least partially removing the solvent or the dispersing medium from the article.

7. The method of claim 1, wherein the composition is an extrudable paste.

8. The method of claim 1, wherein the particles of the first polymer have an average particle size from 50 to 5,000 nm.

9. The method of claim 1, wherein the particles of the second polymer having an average particle size of from 50 nm to 1500 nm.

10. The method of claim 1, further comprising (iv) at least partially removing binder material from the article.

11. A 3D-printable composition comprising particles of a first polymer, particles of a second polymer and at least one binder material capable of binding the polymer particles to form a layer in a part of the composition that has been exposed to the energy source of the additive processing device;
wherein the first polymer is selected from polymers having a melting point above of at least 250° C. or a glass transition temperature (Tg) of greater than 70° C. and is not a fluoropolymer and wherein the second polymer is a fluoropolymer;
wherein the binder material is polymerizable and capable of binding the polymer particles to form a layer comprising the polymer particles by polymerizing in a part of the composition that has been exposed to the energy source of the additive processing device; or the binder material is capable of binding the polymer particles to form a layer comprising the polymer particles in a part of the composition that has been exposed to the energy source of the additive processing device by melting upon exposure to the energy source.

12. An article comprising the composition of claim 11, wherein the composition is shaped and comprises from 5% to 35% by weight of the binder material, from 10% to 80% by weight of the first polymer and from 10 to 80% by weight of the second polymer and from 0 to 15% by weight of water and from 0% to 30% by weight of other ingredients, wherein the total amounts of ingredients is 100% by weight.

13. The article of claim 12, wherein the binder material is polymerized

14. The article of claim 12, wherein the binder material is selected from hydrocarbons having a melting point above 40° C., preferably above 60° C. and degrade (combust) at a temperature below the melting point of the first polymer and/or the second polymer.

15. The article of claim 12 made by the method of claim 1.

16. (canceled)

17. (canceled)

18. The 3D printable composition of claim 11, wherein the first polymer is selected from the group consisting of polyaryl ether ketones (PAEK), polyphenylene sulfide (PPS), polyphenylene sulfones (PPSO2), polyamides (PA), polyimides (PI), polyamide imides (PAI), and polyether imides (PEI) and combinations thereof, and wherein the group of polyaryl ether ketones (PAEK) comprises the group consisting of polyether ketones (PEK), polyether ether ketones (PEEKs), polyether ketone ketones (PEKKs), polyether ether ether ketones (PEEEKs), polyether ether ketone ketones (PEEKKs), and polyether ketone ether ketone ketones (PEKEKK) and combinations thereof.

19. The article of claim 12, wherein the first polymer is selected from the group consisting of polyaryl ether ketones (PAEK), polyphenylene sulfide (PPS), polyphenylene sulfones (PPSO2), polyamides (PA), polyimides (PI), polyamide imides (PAI), and polyether imides (PEI) and combinations thereof, and wherein the group of polyaryl ether ketones (PAEK) comprises the group consisting of polyether ketones (PEK), polyether ether ketones (PEEKs), polyether ketone ketones (PEKKs), polyether ether ether ketones (PEEEKs), polyether ether ketone ketones (PEEKKs), and polyether ketone ether ketone ketones (PEKEKK) and combinations thereof.
